(19) United States
(12) Patent Application Publication
(10) Pub. No.: US 2026/0274571 A1
(43) Pub. Date: Sep. 17, 2026

(54) GRID FRAMEWORK STRUCTURE STORAGE SYSTEM

(71) Applicant: Ocado Innovation Limited, Hatfield (GB)

(72) Inventors: Ian PARKS, Hatfield (GB); Leslie WYNN, Hatfield (GB)

(21) Appl. No.: 19/668,866

(22) Filed: May 6, 2026

Related U.S. Application Data
(63) Continuation of application No. PCT/EP2024/081891, filed on Nov. 11, 2024.

(30) Foreign Application Priority Data
Nov. 10, 2023 (GB) 2317307.3

(51) Int. Cl. B65G 1/04

(52) U.S. Cl. CPC B65G 1/0478; B65G 1/0464

(57) ABSTRACT

A grid framework structure for supporting one or more robotic load handling devices operative on the grid framework structure, the grid framework structure including a supporting framework structure with a plurality of storage columns, each of the plurality of storage columns arranged to accommodate a stack of storage containers; and a track system including a plurality of tracks arranged to form a grid pattern with a plurality of grid cells, the track system being mounted on the supporting framework structure so each stack of storage containers is arranged below a grid cell; where each of the plurality of storage columns includes at least one tote guide for guiding the grabber device in a substantially vertical direction through a grid cell, said at least one tote guide being arranged such that, in use, the grabber device is guided through the grid cell along at least one sidewall of the grabber device.

### RELATED APPLICATIONS

This application is a continuation application of International Patent Application No. PCT/EP2024/081891 filed 11 Nov. 2024 and entitled “A Grid Framework Structure Storage System,” which claims priority to UK Patent Application No. GB2317307.3 filed 10 Nov. 2023 and entitled “A Grid Framework Structure Storage System”; the entire contents of both of which applications are incorporated herein by reference.

### FIELD OF INVENTION

The present invention relates to the field of remotely operated load handling devices on tracks located on a grid framework structure for handling storage containers or bins stacked in the grid framework structure, more specifically to a grid framework structure for supporting remotely operated load handling devices.

### BACKGROUND

Storage and retrieval systems 1 comprising a three-dimensional storage grid framework structure, within which storage containers/bins/totes are stacked on top of each other, are well known. PCT Publication No. WO2015/185628A (Ocado) describes a known storage and fulfilment or distribution system in which stacks of bins or containers are arranged within a grid framework structure. The bins or containers are accessed by load handling devices remotely operative on tracks located on the top of the grid framework structure. A system of this type is illustrated schematically in FIGS. 1 to 3 of the accompanying drawings.

As shown in FIGS. 1 and 2, stackable containers, known as storage bins or containers 10, are stacked on top of one another to form stacks 12. The stacks 12 are arranged in a grid framework structure 14 in a warehousing or manufacturing environment. The grid framework structure is made up of a plurality of storage columns or grid columns. FIG. 1 is a schematic perspective view of the grid framework structure 14, and FIG. 2 is a top-down view showing a stack 12 of bins 10 arranged within the grid framework structure 14. Each bin 10 typically holds a plurality of product items (not shown), and the product items within a bin 10 may be identical, or may be of different product types depending on the application.

In detail, the grid framework structure 14 comprises a plurality of vertical uprights or upright members or upright columns 16 that support horizontal grid members 18, 20. A first set of parallel horizontal grid members 18 is arranged perpendicularly to a second set of parallel horizontal grid members 20 to form a track system or grid structure or grid 15 comprising a plurality of grid cells 17. Each grid cell in the grid framework structure has at least one grid column for storage of a stack of containers. For the avoidance of doubt, the term “grid framework structure” is used to mean a three-dimensional structure within which the storage containers are stored, and the terms “track system”, “grid structure” and “grid” are used interchangeably to mean the two-dimensional structure in a substantially horizontal plane upon which the load handling devices operate. The grid cell has an opening to allow a load handling device to lift a container or storage bin through the grid cell. In the track system, the first set of parallel horizontal grid members 18 intersect the second set of parallel horizontal grid members at nodes. The track system is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10. The grid framework structure can be considered as a rectilinear assemblage of vertical or upright members supporting a grid formed from the intersecting horizontal grid members, i.e. a four wall shaped dimensional framework.

The top level of the grid framework structure 14 includes rails or tracks 22 arranged in a grid pattern across the top of the stacks 12 to define a track system. Referring additionally to FIG. 3, the rails 22 support a plurality of load handling devices 30. The track system comprises a first set 22a of parallel rails 22 to guide movement of the robotic load handling devices 30 in a first direction (for example, an X-direction) across the top of the grid framework structure 14, and a second set 22b of parallel rails 22, arranged perpendicular to the first set 22a, to guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. For the purpose of the present invention, the term “robotic load handling device” and “load handling device” are used to mean the same device.

The track or rail can be a separate component to the grid member (sometime referred to as a ‘track support’) or alternatively, the track is integrated into the grid member as a single body, i.e. forms part of the grid member. For example, each of the first and second sets of horizontal grid members 18, 20 of the track system can function as a track support structure and the first and second sets of tracks of the track system can be mounted to the track support structure for guiding the load handling devices in two dimensions on the track system.

A known load handling device otherwise known as a bot 30 shown in FIGS. 4 and 5 comprising a vehicle body 32 is described in PCT Patent Publication No. WO2015/019055 (Ocado), and corresponding U.S. Pat. No. 10,000,337, which is hereby incorporated by reference in its entirety, where each load handling device 30 only covers a single grid space or grid cell of the grid framework structure 14. Here, the load handling device 30 comprises a wheel assembly comprising a first set of wheels 34 consisting of a pair of wheels on the front of the vehicle body 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the track system.

The load handling device 30 is equipped with a container lifting mechanism or crane mechanism to lift a storage container from above. The crane mechanism comprises a winch tether or cable 38 wound on a spool or reel (not shown) and a grabber device 39 in the form of a lifting frame. The lifting frame is usually made of the metal, e.g. steel or aluminium, and has a rectilinear or square shape corresponding to the cross-sectional shape of the storage container. The container lifting mechanism comprises a set of lifting tethers 38 extending in a vertical direction and connected nearby or at the four corners of the lifting frame 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2. A lifting drive mechanism such as a motor drives rotation of the spool or reel to raise or lower the grabber device.

The wheels 34, 36 are arranged around the periphery of a cavity or recess, known as a container-receiving recess or container receiving space 40, in the lower part. The recess is sized to accommodate the container 10 when it is lifted by the crane mechanism, as shown in FIG. 5 (a and b). When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS) in which case the container receiving space is located below a cantilever of the load handing device. In this case, the grabber device is hoisted by a cantilever such that the grabber device is able to engage and lift a container from a stack into a container receiving space below the cantilever.

To erect the grid framework structure in the art, a plurality of vertical uprights are individually positioned one piece at a time in a grid-like pattern on the ground. The assembling of individual vertical uprights together one piece at a time is sometimes referred to as “stick-built” structures. The “stick-built” approach of the assembling the grid framework structure requires numerous time-consuming adjustments to be made for reliable operation of the robotic load handling devices on the tracks. The height of the vertical uprights and thus the level of the grid mounted thereon is adjusted by one or more adjustable feet at the base or bottom end of each of the vertical uprights. A sub-group of the vertical uprights are braced together to provide structural stability to the grid framework structure. The vertical uprights are interconnected at their top ends by grid members so that the grid members adopt the same grid pattern as the vertical uprights, i.e. the vertical uprights support the grid members at the point or node where each of the grid members intersect in the grid pattern. For the purpose of explanation of the present invention, the points or junctions where the grid members intersect or are interconnected constitute the nodes of the track system and correspond to the area where the track system is supported by a vertical upright. The resultant grid framework structure can be considered as a free standing rectilinear assemblage of upright columns supporting the grid formed from intersecting horizontal grid members, i.e. a four wall shaped framework.

The arrangement of the vertical uprights provides multiple vertical storage columns for the storage of one or more containers in a stack. The status quo in the industry is to guide the grabber device and a storage container connected to the grabber device along the corners of the grabber device and/or storage container. The vertical uprights supporting the track system help to guide the grabber device of the lifting mechanism as the grabber device engages with a container within the grid framework structure and is lifted towards the load handling device operative on the grid. WO2019/101367 (Autostore Technology AS) teaches a free-standing storage grid requiring a less extensive auxiliary grid supporting structure by integrating a grid supporting structure in the storage grid structure. The supporting structure is made up of multiple vertical profiles interconnected at their top ends by rails. Four profiles make up a storage column, in which multiple storage bins may be stacked. Each of the column profiles comprise four corner sections, wherein each corner section is arranged to accommodate a corner of a storage bin, and the inner periphery of the port column may be defined by a rectangle delimited by the inner periphery of a corner section of each of the four column profiles defining the port column. In detail, the profiles have a cross-section comprising a hollow centre section and four corner sections. Each corner section comprises two perpendicular bin guiding plates that are arranged to accommodate a corner of a storage bin or a corner of a stack of storage bins. The four corner sections, one from each of the four profiles, ensure that a storage bin introduced into the storage column is guided into a correct position relative to both any storage bin already present in the storage column and the stacks of storage bins in the surrounding storage columns.

The size of the grid framework structure and thus the ability to store containers containing different items or stock keeping units (SKUs) is largely dependent on the number of vertical uprights spanning over a given footprint of the grid framework structure. However, one of the biggest bottlenecks in the building of a fulfilment or distribution centre is the erection of the grid framework structure. The time and cost to assemble the grid framework structure represents a huge proportion of the time and cost to build a fulfilment or distribution centre. The biggest and the most time consuming operation involves erecting the vertical uprights individually and fixing the track system to the vertical uprights.

A grid framework structure that is able to guide the storage containers in a vertical direction through a grid cell without the deficiencies described above is thus sought.

### SUMMARY OF THE INVENTION

The present invention has mitigated the above problem by removing the need to engage the corners of the grabber device and/or the storage container when guiding the grabber device and/or the storage container vertically along a storage column. Instead of the need of the grid framework structure to accommodate the storage containers at the corners of the storage containers when guiding the grabber device vertically along a storage column, the present invention guides the grabber device in a vertical direction along the storage column by contacting the sidewalls or sides of the grabber device. The problem with accommodating the grabber device and/or storage containers at its corners is the risk that the grabber device and/or storage container may twist if any one of the corners of the grabber device and/or storage containers disengages from the guides. With the guides comprising the two perpendicular bin or tote guiding plates at the four corner sections of the vertical uprights, ensuring that the bin guiding plates correctly guides the grabber device and the storage container connected to the grabber device along the storage column is very much dependent on the stiffness of the vertical uprights. Should any of the vertical uprights deflect or flex under any lateral forces exerted by the grabber and/or storage container as they are being hoisted by a robotic load handling device operative on the track system, there is a risk that any one of the tote guiding plates connected to the vertical uprights may disengage from the corner of the grabber device and/or the storage container. One way to overcome this problem is to over engineer the vertical uprights so as to strengthen the vertical uprights from any lateral forces. However, this will not only increase the cost of the grid framework structure but the overall weight of the grid framework structure, which in turn increases the reliance of the grid framework structure to having a much thicker foundation to support the grid framework structure on the ground.

By contacting one or more sidewalls of the grabber device and/or the storage container as the grabber device and/or the storage container is/are being hoisted vertically along a storage column through a grid cell removes the reliance to guide the grabber device and/or storage containers at their corners. This removes the need to over engineer the vertical uprights at the corners of the storage columns. Thus, the present invention provides a grid framework structure for supporting one or more robotic load handling devices operative on the grid framework structure, each of said one or more robotic load handling devices comprising a) a wheel assembly for guiding the load handling device on the track system; b) a container-receiving space located above the track system; and c) a container lifting mechanism arranged to lift a container from a stack into the container-receiving space, said container lifting mechanism comprises a set of lifting tethers and a grabber device for releasable connection to a storage container, the grid framework structure comprising:
a supporting framework structure comprising a plurality of storage columns, each of the plurality of storage columns being arranged to accommodate a stack of storage containers;
a track system comprising a plurality of tracks arranged to form a grid pattern comprising a plurality of grid cells, said track system is mounted on the supporting framework structure such that each stack of storage containers is arranged below a grid cell;
wherein each of the plurality of storage columns comprises at least one tote guide for guiding the grabber device in a substantially vertical direction through a grid cell, said at least one tote guide being arranged such that, in use, the grabber device is guided through the grid cell along at least one sidewall of the grabber device.

Preferably, the grabber device comprises a lifting frame and the at least one tote guide comprises at least one guide surface arranged in a given storage column such that, in use, the lifting frame is guided along the storage column by the at least one guide surface contacting the at least one sidewall or side of the lifting frame. To guide the grabber device and/or storage container along the at least one sidewall, the at least one tote guide in a given storage column is interposed between the intersections of the plurality of tracks, i.e. between the nodes of the track system, i.e. the at least one tote guide is a discrete tote guide interposed extending from between the nodes of the track system.

Preferably, each of the at least one tote guide is configured to engage with a single sidewall of the grabber device.

To reduce the need to have separate tote guides in adjacent or neighbouring storage columns, optionally, the at least one tote guide comprises a first guide surface and a second guide surface, the first guide surface being arranged to guide the grabber device in a substantially vertical direction through a grid cell and the second guide surface being arranged to guide the grabber device in a substantially vertical direction through an adjacent or neighbouring grid cell. To provide a tote guide comprising a first guide surface and a second guide surface, each of the plurality of tote guides has a cross-sectional profile that is substantially U-shaped or C-shaped. The U-shaped or C-shaped cross-sectional profile of the tote guide provides structural rigidity in the lateral direction by virtue of their opposing flanges and thereby, reduce the risk of the tote guides deflecting by lateral forces as the grabber device is hoisted in a vertical direction along the storage column. The reduced number of tote guides also enables easy access into the interior of the grid framework structure to gain access to one or more storage containers in one or more stacks in the grid framework structure. More importantly, entry into the interior of the grid framework structure to access one or more storage containers is paramount for fire safety and to be able to extinguish any fires within the grid framework structure. The reduced number of tote guides in the grid framework structure helps to provide a passageway to gain entry into the interior of the grid framework structure.

To assist with the guiding of the grabber device in the vertical direction along the at least one tote guide, optionally the at least one tote guide comprises a tote guide track for engaging with the grabber device, said tote guide track extending in a longitudinal direction along the tote guide. Optionally, the tote guide track comprises an elongated depression extending in the longitudinal direction of the at least one tote guide for engaging with the grabber device. For example, the elongated depression is configured to cooperate with one or more rollers or wheels mounted to the lifting frame of the grabber device.

Optionally, the supporting framework structure comprises a plurality of prefabricated frames arranged in a three dimensional grid pattern comprising a plurality of modular storage cells for the storage of a plurality of stacks of storage containers such that adjacent modular storage cells share a common prefabricated frame, each of the plurality of prefabricated frames lying in a vertical plane and comprising a plurality of vertical members braced by a bracing member. Optionally, the bracing member comprises one or more horizontal and/or diagonal bracing members. Optionally, each of the prefabricated frames comprises an A-frame. In contrast to a “tick-built” approach to the assembling the grid framework structure discussed in the introductory section of the description requiring numerous time-consuming adjustments to be made to the level of the rail or track system for reliable operation of the robotic load handling devices on the tracks, the grid framework structure according to the present invention is erected from a plurality of prefabricated panels or frames, wherein each of the plurality of prefabricated panels or frames is assembled from a sub-group of the vertical members braced together by one or more bracing members. For the purpose of definition, the term “prefabricated” in the context of the grid framework structure is construed to cover pre-assembling or manufacturing sections of the grid framework structure prior to assembly of the grid framework structure on site so that the grid framework structure can be assembled at a different location to the manufacture of the prefabricated sections of the grid framework structure, wherein each of the prefabricated sections comprises a plurality of the parts or components of the grid framework structure. The different location can be a location remote from where the grid framework structure is assembled, i.e. in another building, or alternatively, assembled in the same location but in a different area of the same location, e.g. in a different area of the same building. In the context of the term “panels”, the prefabricated panels are formed from bracing together a sub-group of the vertical members in a single plane, e.g. in a single vertical plane. Preferably, the bracing member is a horizontal bracing member.

The prefabricated panels or frames are assembled together in a three dimensional grid pattern to form a plurality of modular storage cells, wherein each of the modular storage cells is sized to store a plurality of stacks of storage containers, i.e. each of the modular storage cells adopts an open storage space for the storage of a plurality of stacks of storage containers. The prefabricated modular panels are load bearing in the sense that when assembled together to form the supporting framework structure, they provide a load bearing structure to support one or more load handling devices moving on the track system mounted to the supporting framework structure. Having each of the prefabricated modular panels extend in a single plane also facilitates the ability to flat pack the supporting framework structure for transport. The prefabrication of the modular panels permits quick assembly of the supporting framework structure at a site or within a building. This has the advantage that the supporting framework structure can be constructed in existing vacant buildings or warehouses. Detail of assembling the grid framework structure from prefabricated frames is discussed in WO2022034195 (Ocado Innovation Limited), and counterpart U.S. Patent Application Publication No. US20250066120, the entire content of which is incorporated herein by reference.

As it is not necessary for the at least one tote guide to be load bearing in the sense to bear the weight of the track system and any robotic load handling devices operable on the track system, lower cost manufacturing methods can be used to fabricate the tote guides. Optionally, the at least one tote guide is formed from a sheet metal blank folded along parallel fold lines that extend longitudinally along the sheet metal blank to form two guide surfaces. Examples of folding a sheet metal blank into a tote guide include but is not limited to cold rolling. Moreover, the removal or reduction of the need to be load bearing in the substantially vertical direction increases the design freedom of the at least one tote guide to correctly guide the grabber device in the vertical direction along the storage column and through a grid cell. For example, more emphasis can be provided in the fabrication of the tote guide to increase lateral support of the grabber device when guiding in the vertical direction to prevent deflection or distortion of the tote guides.

Optionally, the at least one tote guide comprises a plurality of tote guides, each of the plurality of tote guides being arranged in the storage column to engage with a different sidewall of the grabber device. Optionally, the plurality of tote guides are arranged such that, in use, the grabber device is guided along at least two sidewalls of the storage grabber device. Optionally, each of the plurality of tote guides being arranged in the storage column for constraining the movement of the grabber device in a first direction and in a second direction respectively, the second direction being substantially perpendicular to the first direction.

To constrain movement of the grabber device in the first direction and in the second direction when being hoisted in the vertical direction, optionally, the at least one tote guide comprise a first retention surface for constraining movement of the grabber device in a first direction and a second retention surface for constraining movement of the grabber device in a second direction, the second direction being substantially perpendicular to the first direction.

The at least one tote guide may be load bearing and provide structural support to the track system. Advantageously, this will reduce deflection in the track system.

The at least one tote guide and at least one tote guide in an adjacent grid cell may be braced together with at least one bracing member. Advantageously, this will reduce deflection in the track system. The at least one tote guide in a given storage column may be braced together with three tote guides each in a respective adjacent storage column, the four storage columns being arranged in a 2×2 grid and the four tote guides being arranged around the central node of the 2×2 grid. The four adjacent tote guides may be braced together with a cross-shaped spacer having four perpendicular extending portions each connected to a respective one of the four tote guides.

The at least one tote guide may be configured to connect to the underside of the track system using a snap-fit arrangement.

The present invention provides a storage and retrieval system comprising:
i) a grid framework structure according to the present invention;
ii) a plurality of stacks of containers arranged in storage columns located below the track system, wherein each storage column is located vertically below a grid cell;
iii) a plurality of load handling devices for lifting and moving containers stacked in the stacks, the plurality of load handling devices being remotely operated to move laterally on the track system above the storage columns to access the containers through the grid cells, each of said plurality of load handling devices comprising:
   a) a wheel assembly for guiding the load handling device on the track system;
   b) a container-receiving space located above the track system; and
   c) a container lifting mechanism arranged to lift a single container from a stack into the container-receiving space.

To guide the grabber device along the sidewalls of the grabber device, optionally, the container lifting mechanism comprise a lifting frame comprising one or more gripper elements that is configured to releasably engage with the storage container and a lifting drive mechanism for hoisting the lifting frame in the vertical direction, said lifting frame being configured to interact with the at least one tote guide as it is guided in the vertical direction along the storage column. Optionally, the lifting frame comprises at least one rub or wear strip, said at least one rub or wear strip is configured to interact with the at least one tote guide when the grabber device is guided in the vertical direction along the storage column. To reduce the friction between the at least one rub strip or wear strip and the at least one tote guide, optionally, that at least one rub or wear strip comprises a plastic material, e.g. polyurethane or PTFE (polytetrafluoroethylene). Optionally, the lifting frame comprises at least one roller or wheel, said at least one roller or wheel is configured to interact with the at least one tote guide when the grabber device is guided in the vertical direction along the storage column.

### DESCRIPTION OF DRAWINGS

Further features and aspects of the present invention will be apparent from the following detailed description of an illustrative embodiment made with reference to the drawings, in which:

FIG. 1 is a schematic diagram of a grid framework structure according to a known system,

FIG. 2 is a schematic diagram of a top down view showing a stack of bins arranged within the supporting framework structure of FIG. 1.

FIG. 3 is a schematic diagram of a known storage system comprising a load handling device operating on the grid framework structure.

FIG. 4 is a schematic perspective view of the load handling device showing the container lifting mechanism gripping a container from above.

FIGS. 5A-5 are schematic perspective cut away views of the load handling device of FIG. 4 showing a container accommodated within the container receiving space of the load handling device and the container receiving space of the load handling device, respectively.

FIG. 6 is a top plan view of a section of a known grid structure comprising four adjoined grid cells showing the intersections or nodes of the tracks being supported by a vertical upright, each of the grid cells constituting a storage column.

FIG. 7 is a perspective view showing four vertical uprights making up a storage space or storage column within a grid framework structure.

FIG. 8 is a schematic perspective side view of a known grabber device of the container lifting mechanism.

FIG. 9 is a schematic perspective view showing the engagement of the grabber device shown in FIG. 8 with a storage container according.

FIG. 10 is a perspective view showing the arrangement of the tracks and track supports interconnected at their nodes or intersections by a cap plate.

FIG. 11 is a perspective view of a track support or grid member.

FIG. 12 is a perspective view of a cap plate for interconnecting the vertical uprights to the track supports or grid members at the nodes.

FIG. 13 is a perspective cross sectional view of the interconnection of the vertical uprights to the track supports by the cap plate at a node.

FIG. 14 is a perspective view of a track or rail.

FIG. 15 is a perspective view of the grid framework structure according to an embodiment of the present invention.

FIG. 16 is a perspective view of an individual prefabricated frame used to assemble the supporting framework structure.

FIG. 17 is a perspective view of the supporting framework structure of the grid framework structure shown in FIG. 16.

FIG. 18 is a perspective view showing the track system mounted to the support framework structure of FIG. 17.

FIG. 19a is an isometric view of the grid framework structure showing the spatial distribution of the tote guides within the supporting framework structure.

FIG. 19b is a top plan view of the grid framework structure of FIG. 19a showing the spatial arrangement of the tote guides.

FIG. 20a is a schematic drawing showing the interaction between the grabber device and the tote guides at the sides of the grabber device.

FIG. 20b is a schematic drawing showing the tote guides at the corners of the grabber device according to the known system shown in FIG. 1.

FIG. 21 is a perspective view showing the spatial distribution of the plurality of tote guides within the grid framework structure according to the present invention.

FIG. 22a is a perspective view showing the spatial distribution of the plurality of tote guides in relation to the nodes at the intersection of the plurality of tracks.

FIG. 22b is a perspective view showing the spatial distribution of the plurality of tote guides with respect to each other.

FIG. 23 is a perspective view showing the attachment of the tote guides to the track system of the grid framework structure.

FIG. 24 is a perspective view of a portion of the tote guide showing a first end of the tote guide for anchoring to the track system.

FIG. 25 is a perspective view of a portion of the tote guide showing a second end of the tote guide anchored to the floor.

FIG. 26 is a perspective view of a grabber device showing for interacting with the plurality of tote guides shown in FIGS. 19a and 19b.

FIG. 27 is a perspective view of the grabber device shown in FIG. 26 engaging with a storage container.

FIG. 28 is a perspective view of a robotic load handling device operable on the track system hoisting a storage container from a stack of storage containers by the grabber device shown in FIG. 26.

FIG. 29 is a perspective view showing the interaction of the grabber device with the tote guides when hoisting a storage container from a stack.

FIG. 30a is a perspective view showing a robotic load handling device operable on the track system hoisting a storage container from a stack of storage containers by a grabber device.

FIG. 30b is a perspective view showing the interaction of the grabber device with the tote guide, according to a second embodiment of the present invention.

FIG. 31a is a perspective view showing a robotic load handling device operable on the track system hoisting a storage container from a stack by a grabber device.

FIG. 31b is a perspective view showing the interaction of the grabber device with the tote guide, according to a third embodiment of the present invention.

FIG. 32 is a perspective view of a braced tower formed from four tote guides braced together.

FIG. 33 is a perspective view of a spacer used to brace the tote guides together.

FIG. 34 is a perspective view of an anchor used to brace the tote guides together and connect to the floor.

FIG. 35 is a perspective view the upper end of a braced tower formed from four tote guides.

### DETAILED DESCRIPTION

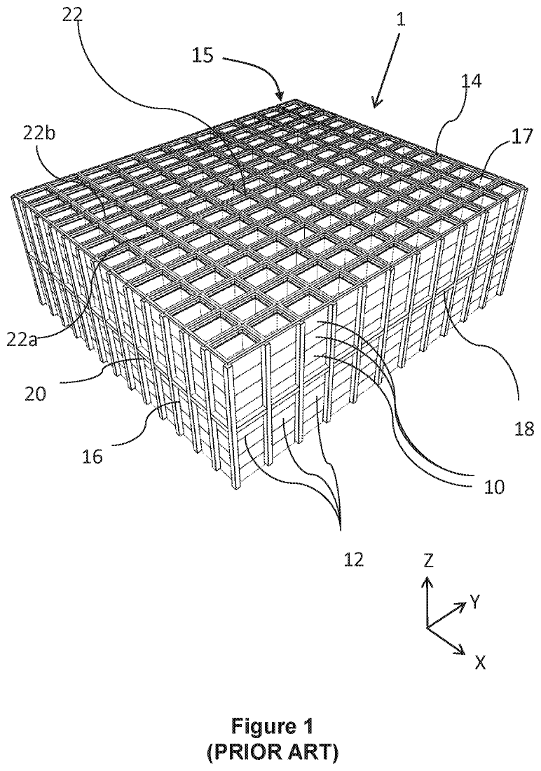

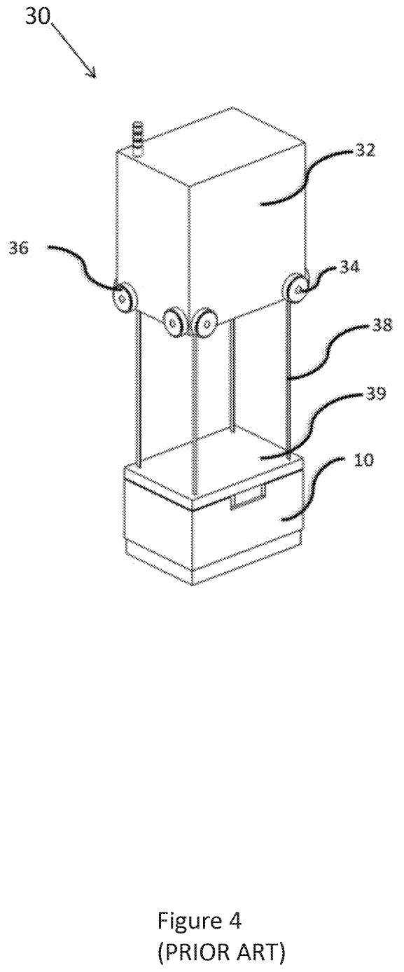

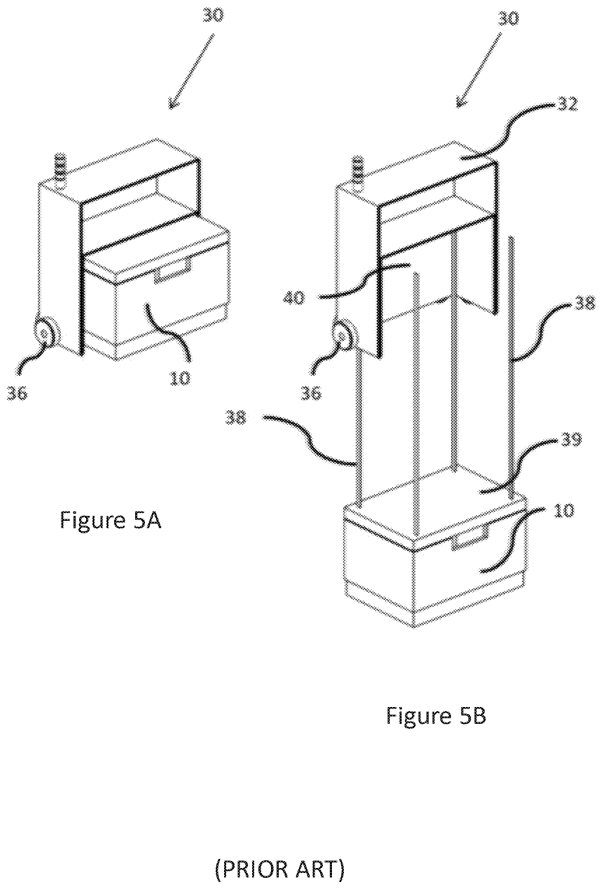

It is against the known features of the storage system such as the grid framework structure and the load handling device described above with reference to FIGS. 1 to 5, that the present invention has been devised.

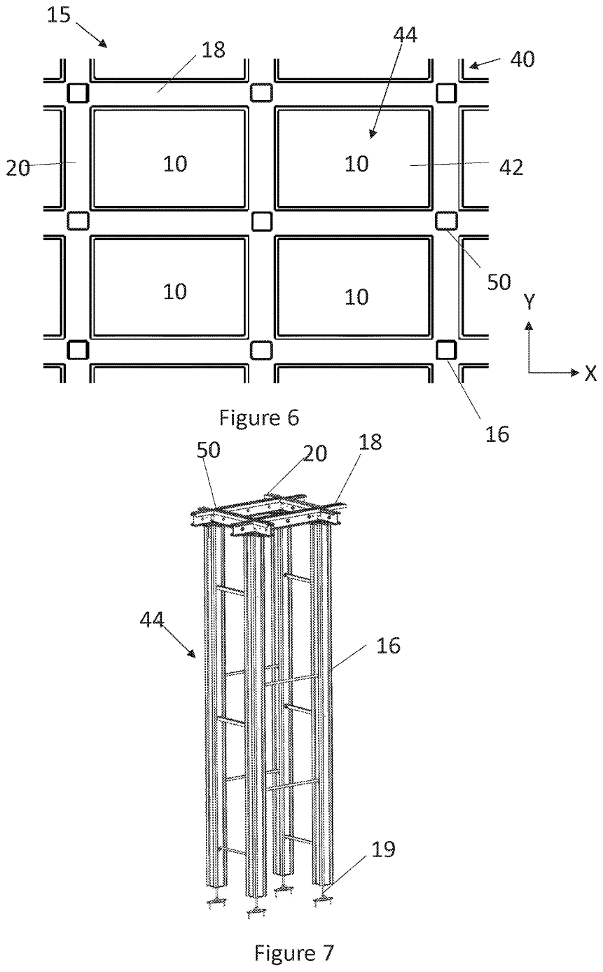

FIG. 6 shows a top view of a section or a portion of a traditional track system 15 comprising four adjoined grid cells 42 and FIG. 7 shows a perspective side view of a single grid cell 42 supported by four vertical uprights 16 to form a single storage column 44 for the storage of one or more containers 10 in a stack. The grid framework structure can be considered to be divided into a supporting framework structure comprising the plurality of vertical uprights and a track system. The track system is supported by the supporting framework structure and comprises a plurality of grid members arranged in a grid pattern comprising a plurality of grid cells.

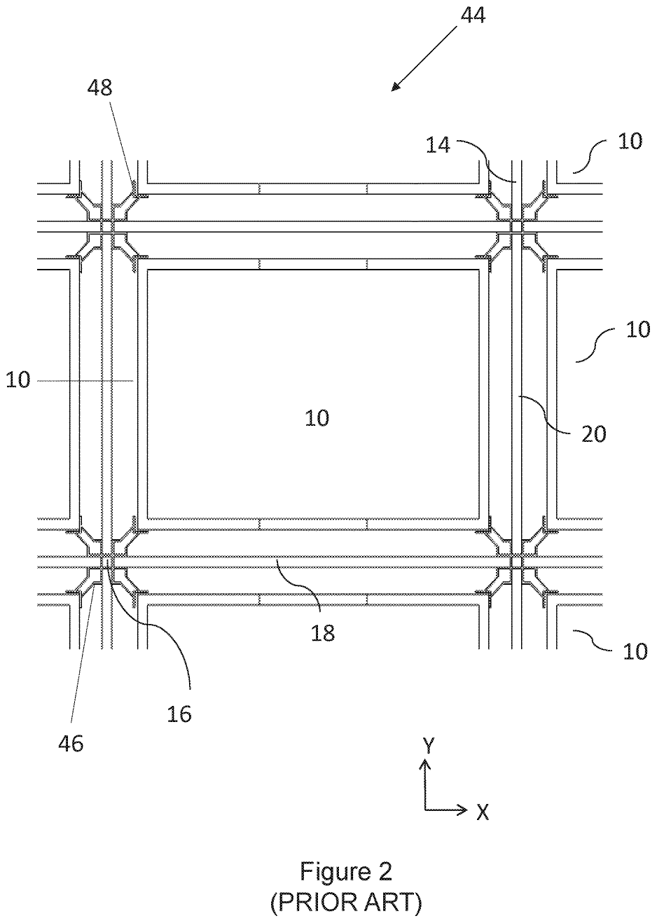

Each of the vertical uprights 16 are generally tubular. In transverse cross-section in the horizontal plane of the storage column 44 shown in FIG. 2, each of the vertical uprights 16 comprises a hollow centre section 46 (typically a box section) with one or more tote guides 48 mounted to or formed at the corners of the hollow centre section 46 that extends along the longitudinal length of the vertical upright 16 for guiding the movement of the grabber device and/or the storage containers along the storage column 44. Further detail of the grabber device is discussed below.

The one or more tote guides 48 comprises two perpendicular container guiding plates. The two perpendicular container guiding plates are arranged to accommodate a corner of a container or a corner of a stack of containers. In other words, each of the corners of the hollow centre section 46 defines two sides of a substantially triangular area which may accommodate a corner of a container or storage bin. The corners are evenly arranged around the hollow centre section 46, such that multiple vertical uprights 16 may provide multiple adjacent storage columns, wherein each vertical upright 16 may be common to or shared by up to four separate storage columns. Also shown in FIG. 7 is that each of the vertical uprights 16 is mounted on an adjustable grid levelling mechanism 19 at the foot of the vertical uprights comprising a base and a threaded shaft that can be extended or retracted to compensate for an uneven floor.

The transverse cross-section in the horizontal plane of the storage column 44 in FIG. 2 shows that an individual storage column 44 is made up of four vertical uprights 16 arranged at the corners of the container or storage bin 10. A storage column 44 corresponds to a single grid cell. The cross section of the vertical upright 16 is constant over the whole length of the vertical upright. The periphery of a container or storage bin in the horizontal plane in FIG. 2 shows the container or storage bin having four corners and the arrangement of four vertical uprights 16 at the corners of the containers or storage bins within the storage column 44. A corner section of each of the four vertical uprights, one from each of the four vertical uprights, ensures that a container or storage bin stored in the storage column 44 is guided into a correct position relative to any container or storage bin stored within the storage column and the stacks of containers or storage bins in the surrounding storage columns. A load handling device operative (not shown) on the track system 15 is able to lift a container or storage bin as it is guided along the vertical uprights 16 through a grid cell 42. The vertical uprights 16 have a dual purpose; (a) to structurally support the track system 40, and (b) to guide the containers or storage bins 10 in the correct position through a respective grid cell 42.

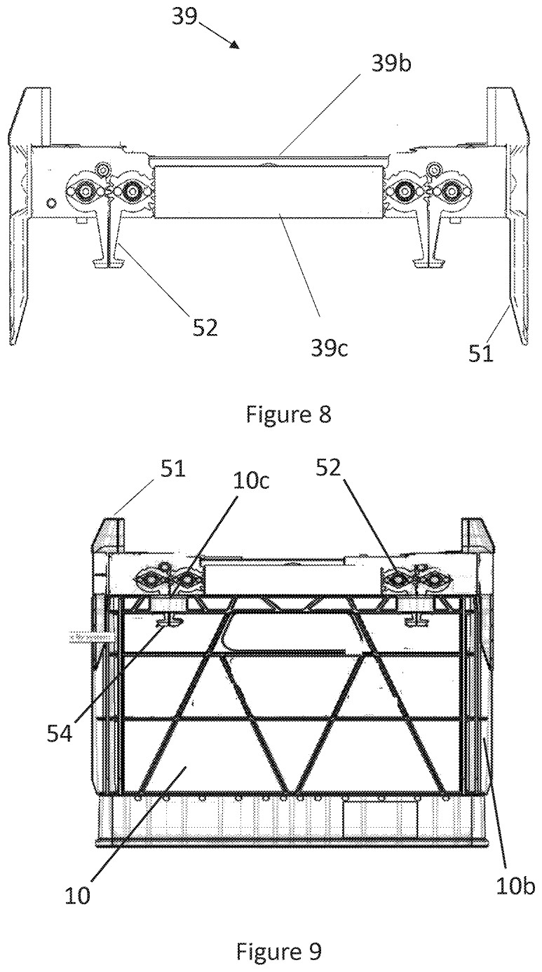

Traditionally, the grabber device 39 is formed as a rectilinear frame (also known as a lifting frame) having four corner sections, sidewalls, a top side 39b and a bottom side 39c (see FIG. 8). To grab a container 10, the grabber device 39 comprises four locating pins or guide pins 51 nearby or at each corner of the grabber device 39 which mate with corresponding cut outs or holes 10b formed at four corners of the storage container 10 and four gripper elements 52 arranged at the bottom side of the grabber device 39 to engage with the rim of the container (see FIG. 9). The locating pins 51 help to not only guide the grabber device in the vertical direction along the storage column but also to properly align the gripper elements 52 with corresponding holes in the rim of the container.

As shown in FIG. 8, each of the gripper elements 52 comprises a pair of wings that are collapsible to be receivable in corresponding holes 10c in the rim of the container and an open enlarged configuration having a size greater than the holes 10c in the rim of the container in at least one dimension so as to lock onto the container (see FIG. 9). The wings are driven into the open configuration by a drive gear. More specifically, the head of at least one of the wings comprises a plurality of teeth that mesh with the drive gear such that when the gripper elements 84 are actuated, rotation of the drive gear causes the pair of wings to rotate from a collapsed configuration to an open enlarged configuration.

When in the collapsed or closed configuration, the gripper elements 52 are sized to be receivable in corresponding holes 10c in the rim of the container as shown in FIG. 9. The foot of each of the pair of wings comprises a stop 54, e.g. a boss, such that when received in a corresponding hole 10c in the rim of the container, the stop engages with an underside of the rim when in an enlarged open configuration to lock onto the container when the grabber device 39 is winched upwards towards the container-receiving portion of the load handling device.

Conventionally, during assembly of the grid framework structure, the individual vertical uprights 16 are erected first. The procedure for assembling the individual vertical uprights 16 is sometimes referred to as a ‘stick-built’ approach. The upper or top ends of the vertical uprights 16 are then interconnected by a plurality of grid members. A top plan view of a section of the track system 15 shown in FIG. 6 shows a series of horizontal intersecting beams or grid members 18, 20 arranged to form a plurality of rectangular frames constituting grid cells 42, more specifically a first a set of grid members 18 extending in a first direction X and a second set of grid members 20 extending in a second direction Y, the second set of grid members 20 running transversely to the first set of grid members 18 in a substantially horizontal plane, i.e. the track system is represented by Cartesian coordinates in the X and Y direction. The term “vertical upright(s)”, “upright member(s)”, “upright”, “vertical members” and “upright column(s)” are used interchangeably in the description to mean the same thing. For the purpose of explanation of the present invention, the points or junctions where the grid members intersect or cross shown by the shaded squares in FIG. 6 can be defined as nodes or intersections 50. It is clearly apparent from the layout of at least a portion or section of a known track system 40 constituting four adjoining grid cells 42 shown in FIG. 6 that each intersection or node 50 of the track system 40 is supported by a vertical upright 16. From the section or at least a portion of the track system 40 shown in FIG. 6, the four adjoining grid cells are supported by nine vertical uprights 16, i.e. three sets of vertical uprights 16 supporting the track system at three rows, where each row comprises three nodes 50.

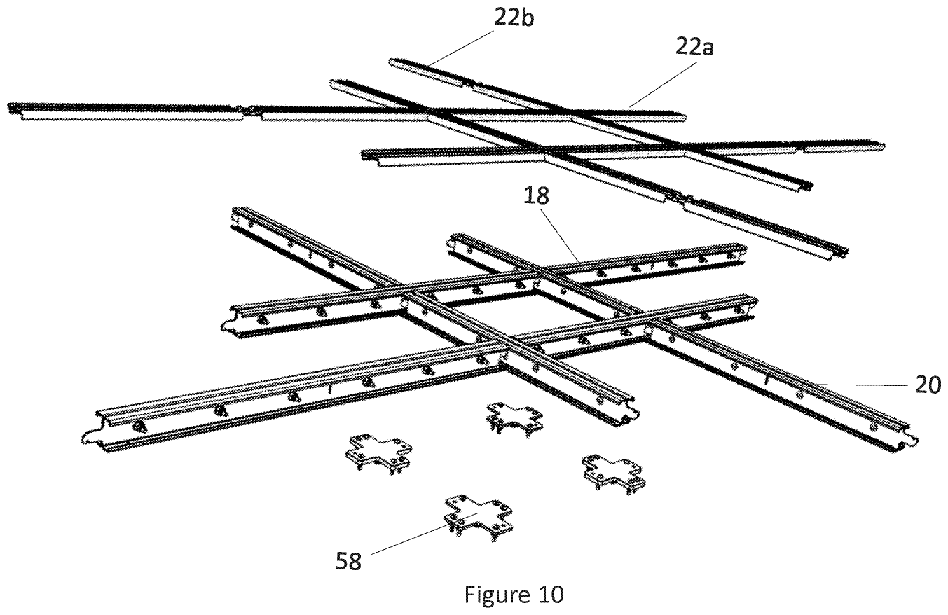

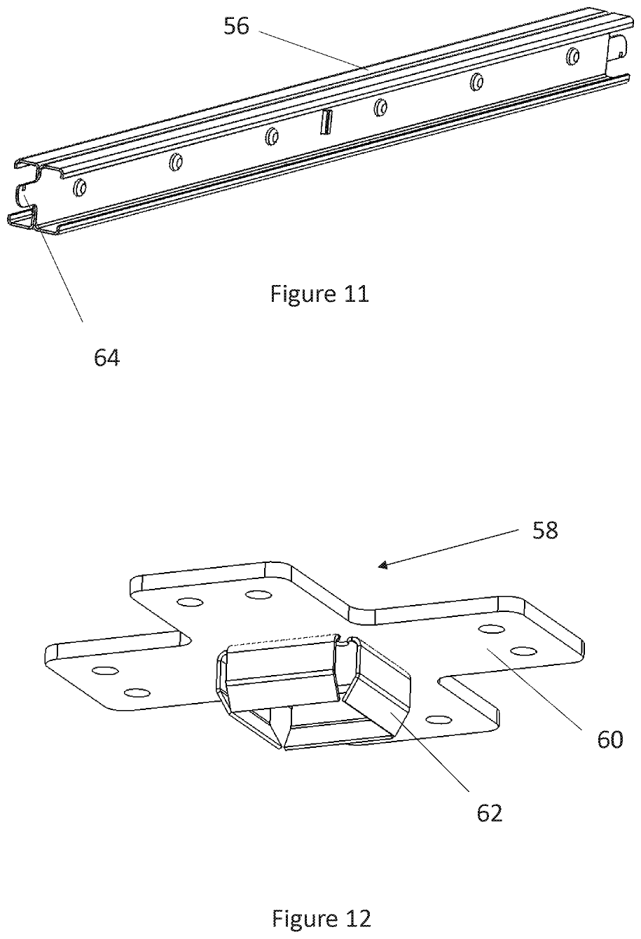

Each of the grid members can comprise a track support 18, 20 and/or a track or rail 22a, 22b (see track system in FIG. 10) whereby the track or rail 22a, 22b is mounted to the track support 18, 20. A load handling device is operative to move along the track or rail 22a, 22b of the present invention. Alternatively, the track 22a, 22b can be integrated into the track support 18, 20 as a single body, e.g. by extrusion. At least one grid member in a set, e.g. a single grid member, can be sub-divided or sectioned into discrete grid elements that can be joined or linked together to form a grid member 18, 20 extending in the first direction or in the second direction. Where the grid members comprise a track support, the track support can also be sub-divided into discrete track support elements that are linked or fixedly connected together to form the track support. The discrete track support elements making up a track support extending in the first axial direction and in the second axial direction are shown in FIG. 10. An individual track support element 56 used to make up a track support 18, 20 is shown in FIG. 11. The track support 18, 20 in transverse cross section can be a solid support of C-shaped or U-shaped or I-shaped cross section, or even double-C or double-U shaped support. In the particular embodiment of the present invention, the track support element 56 is a double back-to-back C section bolted together.

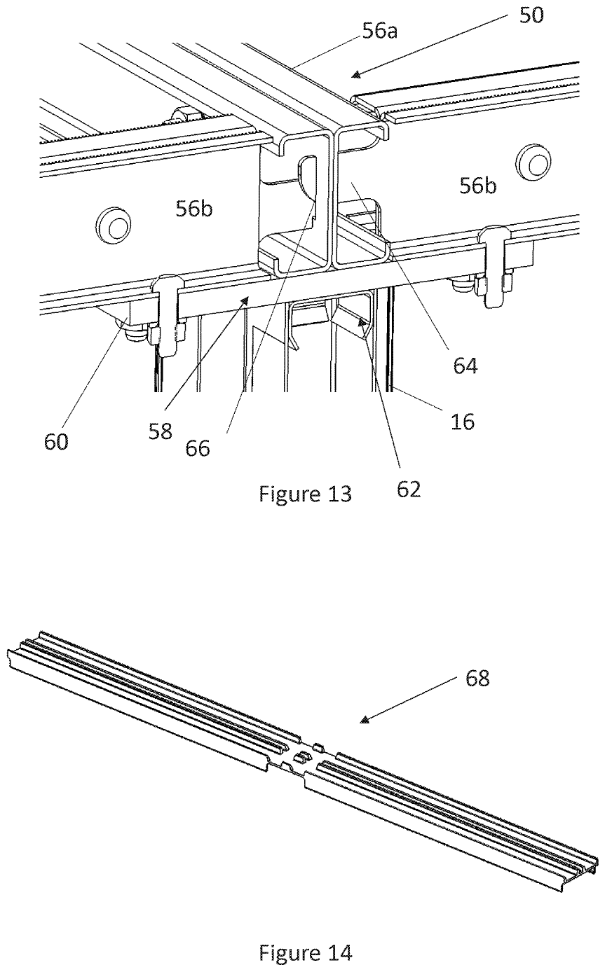

A connection plate or cap plate 58 as shown in FIG. 10 can be used to link or join or fixedly connect the individual track support elements 56 together in both the first and the second direction at the junction where multiple track support elements cross in the track system 15, i.e. the cap plate 58 is used to connect the track support elements 56 together to the vertical uprights 16. As a result, the vertical uprights 16 are interconnected at their upper ends at the junction where the multiple track support elements cross in the track system 15 by the cap plate 58, i.e. the cap plate is located at the node 50 of the track system 15. As shown in FIG. 12, the cap plate 58 is cross shaped having four connecting portions 60 for connecting to the ends or anywhere along the length of the track support elements 56 at their intersections 50. The interconnection of the track support elements to the vertical uprights at the nodes by the cap plate 58 is demonstrated in the cross-sectional profile of the node 50 shown in FIG. 13. The cap plate 58 comprises a spigot or protrusion 62 that is sized to sit in the hollow central section 46 of the vertical upright 16 in a tight fit for interconnecting the plurality of vertical uprights 16 to the track support elements as shown in FIG. 13. Also shown in FIG. 13 are the track support elements 56a, 56b extending in both perpendicular directions corresponding to the first direction (x-direction) and the second direction (y-direction). The connecting portions 60 are perpendicular to each other to connect to the track support elements 56a, 56b extending in the first direction and in the second direction respectively. The cap plate 58 is configured to be bolted to the ends of the track support elements 56a, 56b or along the length of the track support elements forming a rigid connection with the cap plate 58. Each of the track support elements 56a, 56b is arranged to interlock with each other at the nodes to form the track system 40 according to the present invention. To achieve this, distal or opposing ends of each of the track support elements 56a, 56b comprise locking features 64 for interconnecting to corresponding locking features 66 of adjacent track support elements. In the particular embodiment of the present invention, opposing or distal ends of one or more track support elements comprise at least one hook or tongue 64 that is receivable in openings or slot 66 midway along an adjacent track support element 56 at the junction where the track support elements cross in the track system 40. Referring back to FIG. 11 in combination with FIG. 13, the hooks 64 at the end of a track support element 56 are shown received in an opening 66 of an adjacent track support element extending across a vertical upright 16 at the junction where the track support elements 56 cross. Here, the hooks 64 are offered up to an opening 66 either side of a track support element 56b. The opening 66 is halfway along the length of the track support element 56 so that when assembled together, adjacent parallel track support elements 56 in the first direction and in the second direction are offset by at least one grid cell. This is demonstrated in FIG. 10.

To complete the track system 40 once the track support elements are interlocked together in a grid pattern comprising track supports 18 extending in the first direction and track supports 20 extending in the second direction, a track 22a, 22b is mounted to the track support elements 56. The track 22a, 22b is either snap-fitted and/or fitted over the track support 18, 20 in a slide fit arrangement (see FIG. 10). Like the track support, the track comprises a first set of tracks 22a extending in the first direction and a second set of tracks 22b extending in the second direction, the first direction being perpendicular to the second direction. A first set of tracks 22a is sub-divided into multiple track elements 68 in the first direction such that, when assembled, adjacent parallel track elements in the first direction are offset by at least once grid cell. Similarly, a second set of tracks 22b is sub-divided into multiple track elements 68 in the second direction such that, when assembled, adjacent track elements in the second direction are offset by at least one grid cell. This is demonstrated in FIG. 10. An example of a single track element 68 is shown in FIG. 14. As with the track support elements, multiple track elements in the first direction and the second direction are laid together to form a track in both directions. The fitting of the track element 68 to the track support 18, 20 comprises an inverted U-shaped cross-sectional profile that is shaped to cradle or overlap the top of the track support 18, 20. One or more lugs extending from each branch of the U shape profile engage with the ends of the track support 18, 20 in a snap fit arrangement. Equally plausible is that the track 22a, 22b can be integrated into the track supports 18, 20 rather than being separate components.

As can be appreciated from the above description, the process of assembling the grid framework structure involving erecting the vertical uprights, connecting the grid members and mounting the tracks is very time consuming since multiple separate components are necessary to assemble the grid framework structure. The process of erecting the grid framework structure can take several weeks and in a worst case scenario, the process can take several months. As the demand for e-commerce grows rapidly, particularly in the retail sector, there has been an increased demand for distribution centres, otherwise known as customer fulfilment centres (CFCs), in more locations rather than just a few locations that serve major cities in order to fulfil a growing demand from customers. The increased presence of distribution centres in more locations also has the effect of reducing the time to complete the last mile logistics for the movement of goods from the distribution centre to its final destination. Such last mile logistics is also an important consideration in order to keep goods such as perishable grocery products fresh at their final destination. One of the major bottlenecks to providing distribution centres in more locations is the time and cost to erect the grid framework structure. Not only is the time and cost to erect the grid framework structure a cause of concern when setting up a distribution centre, but also the grid framework structure should have the flexibility to be assembled in a number of existing locations including existing warehouses rather than bespoke warehouses purely to house the grid framework structure.

The above problem is mitigated by forming the grid framework structure from fewer structural components than is currently practised described above, while still maintaining the structural integrity of the existing grid framework structure for bearing the weight of one or more robotic load handling devices operative on the grid framework structure. In contrast to the existing grid framework structure as described above, the grid framework structure according to the present invention is erected from prefabricated modular structural components. The prefabricated modular structural components are load bearing in the sense that when assembled together to form the grid framework structure, the prefabricated modular structural components provide a three dimensional load bearing structure to support one or more load handling devices moving on the track system. The use of prefabricated modular structural components to erect the grid framework structure according to the present invention allows the grid framework structure to be assembled at a much faster rate than the traditional ‘stick-built’ approach where individual vertical uprights are initially erected one by one on the floor, and then subsequently mounting the track supports to the upper end of the vertical uprights.

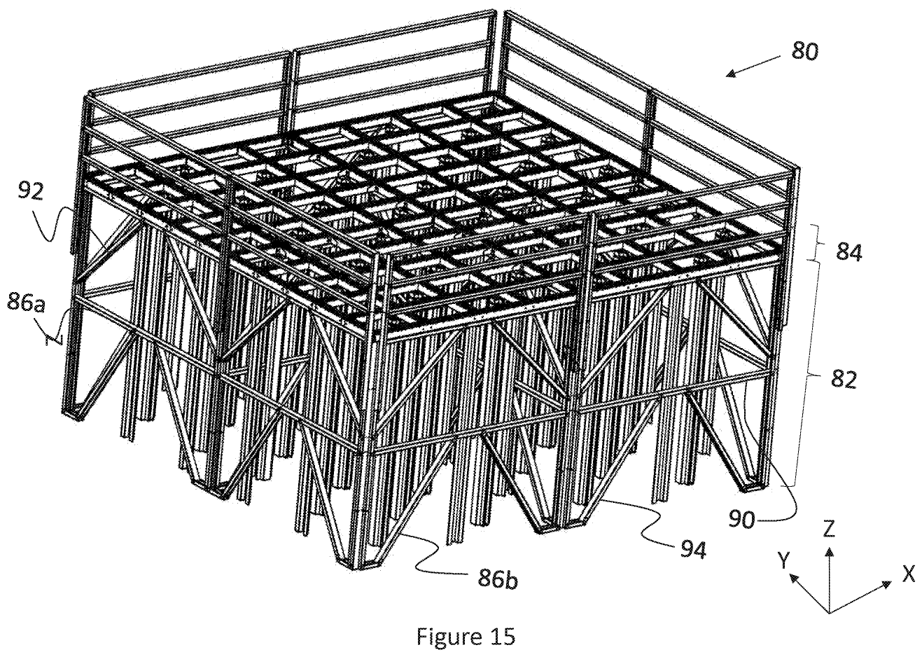

FIG. 15 is a grid framework structure 80 assembled from prefabricated modular structural components according to the present invention. Details of the grid framework structure according to this embodiment of the present invention is described in WO2022034195 (Ocado Innovation Limited), and corresponding US20250066120 (noted previously), which is incorporated herein by reference in its entirety. The grid framework structure 80 can be divided into a supporting framework structure 82, and a track system 84 for guiding movement of one or more robotic load handling devices 30 on the supporting framework structure 82. When assembling the grid framework structure 80, the supporting framework structure 82 is first assembled and then the track system 84 is mounted to the supporting framework structure 82. The track system 84 is raised above the ground by the supporting framework structure 82 to create an open storage space for the storage of multiple stacks of storage containers. The supporting framework structure 82 or the track system 84 or both the supporting framework structure 82 and the track system 84 can be assembled from modular structural components. In the particular embodiment shown in FIG. 15, both the supporting framework structure 82 and the track system 84 are assembled from prefabricated modular structural components to form a three dimensional grid framework structure 80.

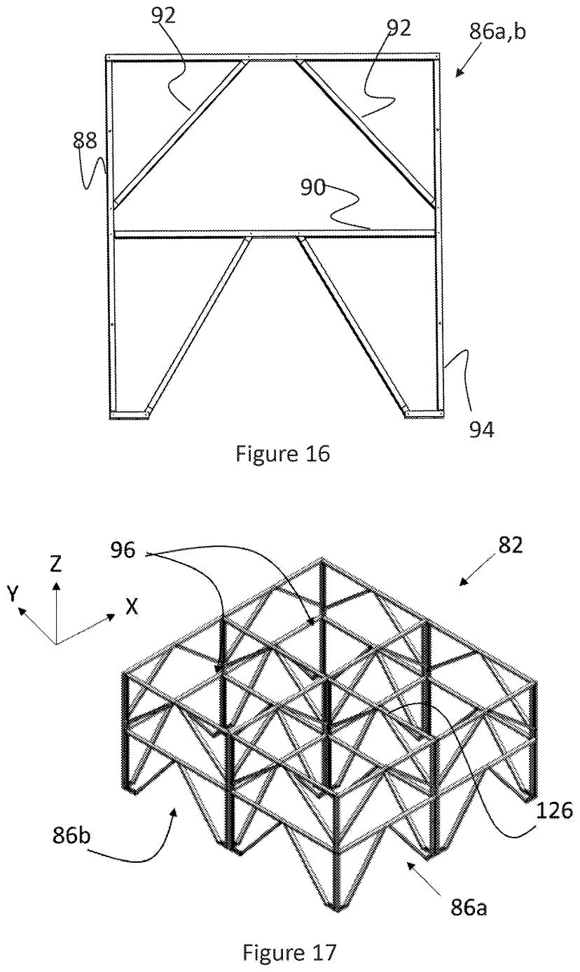

In the particular example of the present invention, the supporting framework structure 82 is formed from a plurality of prefabricated frames or panels 86a,b arranged in a grid pattern to define a three dimensional supporting framework structure. Prefabrication of the frames 86a,b involves assembling and fixing separate components of the supporting framework structure 82 together prior to erecting the supporting framework structure 82 such that the components of each of the prefabricated frames 86a,b lie in a common plane. In other words, the prefabricated frames 86a,b can be envisaged to be planar (see FIG. 16). This enables the prefabricated braced frames 86a,b to be flat packed to facilitate transport. The plurality of uprights 88 of each of the prefabricated braced frames 86a,b are secured together by one or more bracing members 90, 92 extending between the plurality of uprights 88. The one or more bracing members connecting the plurality of uprights lie in the same plane as the plurality of the vertical member such that each of the prefabricated braced frames is planar. This allows ease of assembly of the supporting framework structure 82 since the use of prefabricated frames 86a,b greatly reduces the time and effort to assemble the supporting framework structure 82 rather than erecting a plurality of vertical uprights one by one in a “stick by stick” approach and then mounting the grid structure to the supporting framework structure as currently practised in the art.

In the particular embodiment of the present invention shown in FIG. 16, the one or more bracing members 90, 92 comprises a horizontal bracing member 90 and a diagonal bracing member 92. The bracing allows a sub-group of uprights 88 to be assembled together prior to being assembled in the supporting framework structure 82. Each vertical member 88 of the plurality of vertical member, horizontal bracing members 90 and/or diagonal bracing members 92 can be a solid support beam of I-shape or H-shape or U shaped comprising opposing beam flanges or C shaped or L shaped to enable the vertical members to be braced together by the one or more bracing members. The cross-sectional profile of each of the vertical members 88, horizontal bracing members 90 and the diagonal bracing members 92 in a given prefabricated frame 86a,b can be the same or different.

In the particular embodiment of the present invention, the cross-sectional profile of each of the vertical members 88, horizontal bracing members 90 and the diagonal bracing members 92 in a given prefabricated frame 86a,b are different. The difference in the cross-sectional profile of each of the vertical members 88, horizontal bracing members 90 and the diagonal bracing members 92 in a given prefabricated frame 86a,b helps to improve the structural integrity of the prefabricated frame. One of the main physical characteristics of the supporting framework structure is that the prefabricated frames have sufficient ultimate tensile strength (UTS) to prevent breaking of any one of the components of the prefabricated frames under an applied load but yet have sufficiently flexible to mitigate fatigue as a result of movement of the robotic load handling devices on the track system. The different cross-sectional profiles of the vertical members, horizontal bracing members and diagonal enable the mechanical properties of the prefabricated frames to be tailored to the physical requirements of the supporting framework structure. However, to reduce costs and to improve the structural integrity of the prefabricated braced frame without jeopardising the lightness of the prefabricated braced frame, the load bearing members of each of the prefabricated braced frames can have a single cross-sectional profile. For example, the load bearing members include the uprights 88 and the bracing members 90, 92, i.e. the entire prefabricated braced frame is formed from the same type of load bearing members having a C-shaped cross-section. To reduce cost of manufacture of the grid framework structure, each of the uprights 88 and/or the bracing members 90, 92 can be formed from a folded sheet metal blank having one or more fold lines. Examples of folding the sheet metal blank to form the upright 88 include but is not limited to cold rolling.

The bracing members 90, 92 extending between the plurality of uprights 88 are designed to work in tension and compression similar to a truss. The bracing between the plurality of uprights can be designed in different patterns including cross-bracing, K-bracing, V-bracing and/or eccentric bracing. Cross-bracing, also known as X-bracing, is made of two diagonal bracing members crossing each other. The bracing members in K bracing are arranged to form a K shape between the plurality of uprights. In the particular embodiment of the present invention shown in FIG. 16, the pattern of the bracing members 90, 92 connecting the plurality of uprights 88 of each of the prefabricated braced frames 86a,b shown in FIG. 16 adopts a K bracing pattern providing an A frame. To provide an A shaped frame, each of the plurality of prefabricated frames 86a,b comprises two sets of diagonal bracing members 92; a first set of diagonal bracing members 92 in an upper portion of the prefabricated frame and a second set of diagonal bracing members 92 in a lower portion of the prefabricated frame. The set of diagonal bracing members 92 in the lower portion of the prefabricated frame extends from the horizontal bracing member towards the middle region of the prefabricated frame to the lowermost portion of the prefabricated frame to form legs 94 for mounting the prefabricated frame to the floor. The bracing members 90, 92 are fixedly connected to the uprights 88 by fasteners commonly known in the art. These include but are not limited to welding, bolts, rivets, or a combination thereof. Various lightweight materials can be used in the prefabrication of the frames. These include but are not limited to metal, plastic, or a fibre reinforced composite material. As the grid framework structure is primarily used to store grocery items, the metal type used in the fabrication of the tote guide is preferably sufficiently corrosion resistant in some embodiments. Examples of metals include but is not limited to stainless steel or galvanised steel. The plurality of uprights and/or the bracing members can be formed by folding a sheet metal blank at one or more fold lines, e.g. metal stamping.

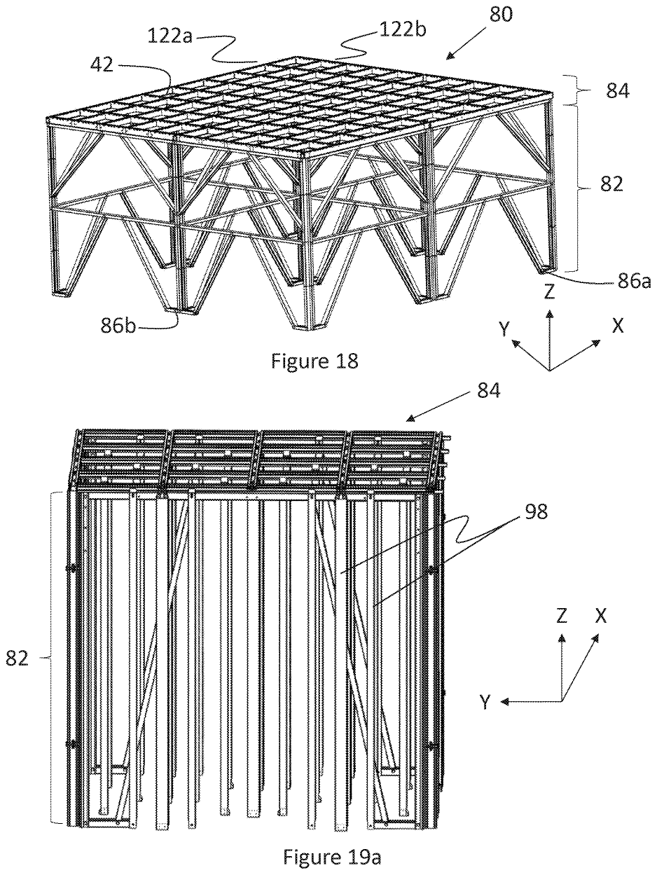

The plurality of the prefabricated frames 86a,b are arranged in a three dimensional grid pattern as shown in FIG. 17 in the sense that the prefabricated frames comprises a first set of parallel prefabricated frames 86a and a second set of parallel prefabricated frames 86b. The first set of parallel prefabricated frames 86a extend in a first direction and the second set of parallel prefabricated frames 86b extend in a second direction, the second direction being substantially perpendicular to the first direction such that the plurality of the prefabricated frames are arranged in a grid pattern comprising a plurality of modular storage cells or spaces 96. The first and second directions can represent X and Y axes of a Cartesian coordinate system. Each of the plurality of prefabricated frames 86a, 86b are sized such that each of the modular storage cells 96 is sized to store a plurality of stacks of storage containers commonly known as storage bins. Connection of adjacent prefabricated frames 86a, 86b in the supporting framework structure 82 involves connecting one of the plurality of uprights 88 of a prefabricated frame 86a extending in the first direction to one of the plurality of uprights 88 of an adjacent prefabricated frame 86b extending in the second direction as demonstrated in FIG. 18. Various fasteners or fixtures known in the art can be used to connect adjacent prefabricated frames together. These include but are not limited to bolts, riveting, welding or even the use of a suitable adhesive.

To guide one or more robotic load handling devices on the supporting framework structure 82, the track system 84 is mounted to the supporting framework structure 82 such that the track system 84 extends across the plurality of modular storage cells 96 created by the plurality of prefabricated frames 86a,b. The track system 84 comprises a plurality of tracks arranged in a grid pattern comprising a plurality of grid cells (see FIG. 18). More specifically, a first set of parallel tracks 122a extending in the first direction and a second set of parallel tracks 122b extending in the second direction, the second direction being substantially perpendicular to the first direction to adopt a grid like pattern. As each of the plurality of modular storage cells 96 of the supporting framework structure 82 is sized to accommodate a plurality of stack of storage containers, each modular storage cell 96 of the supporting framework structure 82 is sized to accommodate a sub-group of two or more grid cells 42 of the track system 84.

The plurality of modular storage cells 96 of the supporting framework structure 82 shown in FIG. 17 generates multiple storage spaces for the storage of a plurality of stacks of storage containers within each of the storage spaces of the supporting framework structure, i.e. an open storage space for the storage of a plurality of stacks of storage containers. In the particular embodiment of the present invention shown in FIG. 18, each of the plurality of the modular storage cells 96 of the supporting framework structure 82 is sized to accommodate twenty grid cells 42 of the track system 84, i.e. a grid pattern of 5 by 4 grid cells. Thus, each of the modular storage cells 96 of the supporting framework structure 82 provides a storage space for the storage of twenty stacks of storage containers. The size of each of the plurality of modular storage cells is not limited to accommodating twenty grid cells of the track system and can be a plurality of grid cells of the track system, i.e. each modular storage cell 96 can accommodate a grid pattern of X by Y grid cells, where X and Y can be any number equal to 2 or greater. In other words, the ratio of the number of grid cells 42 of the track system 84 per modular storage cell 96 of the supporting framework structure 82 is X: 1, where X is any integer greater than one, i.e. each of the plurality of modular storage cells 96 of the supporting framework structure 82 is sized to support a subset of the plurality of grid cells 42 of the track system 84, said subset comprising two or more grid cells 42 of the track system 84.

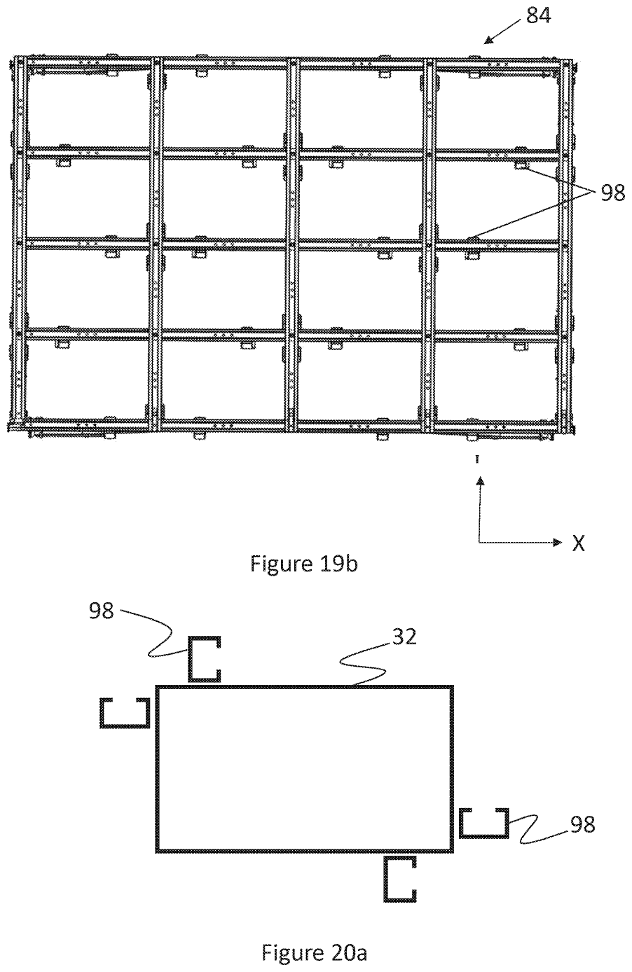

To guide the grabber device and one or more storage containers attached to the grabber device through a respective grid cell 42 of the track system 84 as it is lifted by a robotic load handling device operable on the track system 84, the grid framework structure 80 further comprises a plurality of tote guides 98 (see FIGS. 19a and 19b). In comparison to the conventional stick built approach of the grid framework structure where the tote guides are incorporated into the vertical uprights or vertical members which are largely load bearing for supporting the track system and one or more robotic load handling devices operable on the track system, the plurality of tote guides do not necessarily need to be entirely load bearing to bear the full weight of the track system. This is because the weight of the track system and one or more robotic load handling devices operable on the track system is supported by the prefabricated frames 86a,b arranged to form the supporting framework structure 82 discussed above. As a result, each of the plurality of tote guides 98 can be fabricated from lower cost materials and/or processes. More importantly, the functional characteristics of each of the plurality of tote guides can be tailored to limit movement of the storage containers in the lateral direction (i.e. substantial horizontal direction) as they are being hoisted in a vertical direction along a given storage column. Each of the plurality of tote guides comprises at least one tote guide surface that is configured to contact at least one side wall of the lifting frame of the grabber device as the grabber device is hoisted in the vertical direction along the storage column.

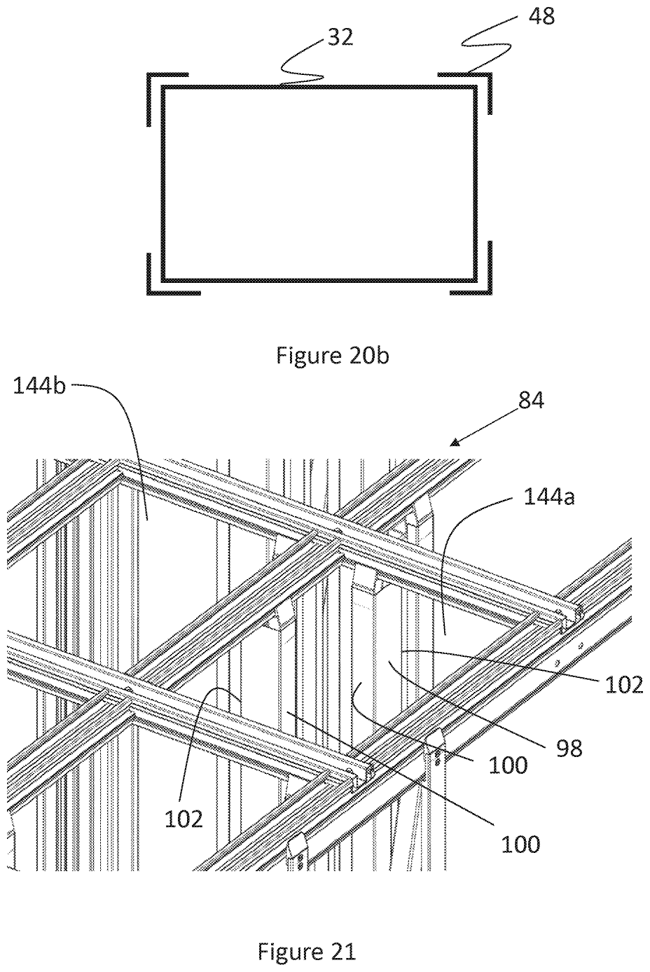

In the particular embodiment of the present invention shown in FIG. 19a and the top plan view show in FIG. 19b, the plurality of tote guides are arranged in the supporting framework structure such that the grabber device and any storage container attached to the grabber device is hoisted or lowered in a vertical direction in a given storage column by being guided along their respective sidewalls rather than engaging their corners as in prior art systems. A comparison between the traditional arrangement of the plurality of tote guides in a given storage column that is configured to interact with the corners of the grabber device and the new arrangement according to the present invention is shown in FIGS. 20a and 20b. As is clearly apparent in FIG. 20a, the cross sectional profile of each of the plurality of plurality of tote guides has a U-shaped or C-shaped profile. The U-shaped or C-shaped cross-sectional profile provides improved stability of each of the plurality of tote guides in the lateral direction in comparison to the perpendicular plates of the traditional tote guides 48 shown in FIG. 20b.

In the arrangement of FIG. 20a, each of the tote guides 98 engages with a single side wall of the grabber device and/or storage container when the storage container is lifted or lowered by a load handling device. By contrast, the corner tote guides 48 as shown in FIG. 20b each engage with two adjacent side walls of the grabber device and/or storage container. Tote guides of the type that engage with one side wall only, such as those illustrated in FIG. 20a, have the advantage of faster assembly. The tote guide only needs to be aligned in one direction, i.e. the direction perpendicular to the side wall, and can be free to float in the direction parallel to the side wall and still be able to engage effectively with the side wall. Corner-type tote guides of the type that engage with two side walls, such as those illustrated in FIG. 20b, require more precise positioning because they need to be aligned in two directions, i.e. the directions perpendicular to both side walls. This requirement for more precise positioning means that the corner-type tote guides 48 need more time to assemble.

Another advantage of tote guides 98 of the time that engage with one sidewall only is that the tote guides can be located at any position along the side wall. The tote guides 98 can be located near the corners of the grid cell (as illustrated in FIG. 20a). Advantageously, this permits tote guides 98 in adjacent cells to be positioned close together, e.g. four tote guides close to the intersection of four cells, enabling these tote guides to be braced together or to share some common structure, as will be described later. Alternatively, the tote guides 98 can be positioned at or near the centre of a side wall. This helps to guide the grabber device and/or storage containers in a smoother and more stable fashion. The U-shaped or C-shaped cross-sectional profile of each of the plurality of tote guides enable the plurality of tote guides to be fabricated from low cost fabrication techniques. For example, each of the plurality of tote guides 98 can formed from a sheet metal blank comprising parallel fold lines extending in a longitudinal direction of the sheet metal blank. Examples of low cost fabrication techniques in the fabrication of the tote guides include but is not limited to extrusion, cold rolling etc. Alternative materials can also be used in the fabrication of each of the plurality of the plurality of tote guides. These include various lightweight materials including but is not limited to plastics, lightweight metals, e.g. aluminium, steel.

Another advantage of the U- or C-shaped cross-sectional profile of the tote guides 98, especially when engaging with a single sidewall, is that there can be a large surface area in contact with the sidewall of the grabber device and/or of the storage container. A flat surface of the U- or C-shape profile has good engagement with the sidewall and enables stable and smooth guiding as the container is lifted or lowered in the storage column.

The arrangement of the plurality of tote guides in the supporting framework is such that each of the plurality of tote guides 98 is shared between adjacent grid cells of the track system as shown in FIG. 21. Thus, each of the plurality of tote guides comprises a first tote guide surface 100 for guiding the grabber device in a vertical direction along a first storage column 144a or through a first grid cell when the robotic load handing device is positioned above the first storage column and a second tote guide surface 102 for guiding the grabber device in a vertical direction along a second storage column 144b or through a second grid cell when the robotic load handling device is positioned above the second column; the second storage column or the second grid cell being adjacent the first storage column or the first grid cell (see FIG. 21). To share each of the plurality of tote guides between adjacent grid cells, the first tote guide surface 100 is opposite the second tote guide surface 102. The first and second tote guides surfaces 100, 102 of each of the plurality of tote guides 98 is provided by the opposing flanges of the U-shaped or C-shaped cross-sectional profile of the tote guide. The sharing of the tote guides 98 between adjacent storage columns also reduces the number of tote guides in the grid framework structure. In the particular embodiment of the present invention shown in FIG. 21, the grabber device is guided in a vertical direction by the plurality of tote guides along at least two of the sides or sidewalls of the grabber device. The reduced number of tote guides provides a passageway in the grid framework structure, more specifically the supporting framework structure, for entry of personal into the supporting framework structure. For example, entry into the supporting framework structure is paramount for the purpose of fire safety and to provide access to fire extinguishing equipment. Entry is also necessary to gain access to one or more storage containers in a storage column. Having a tote guide incorporated into the vertical members and extending from every node of the track system as found in the traditional grid framework structures discussed above inhibits easy entry into the grid framework structure to the extent that the vertical members would have to be cut in order to entry into the grid framework structure.

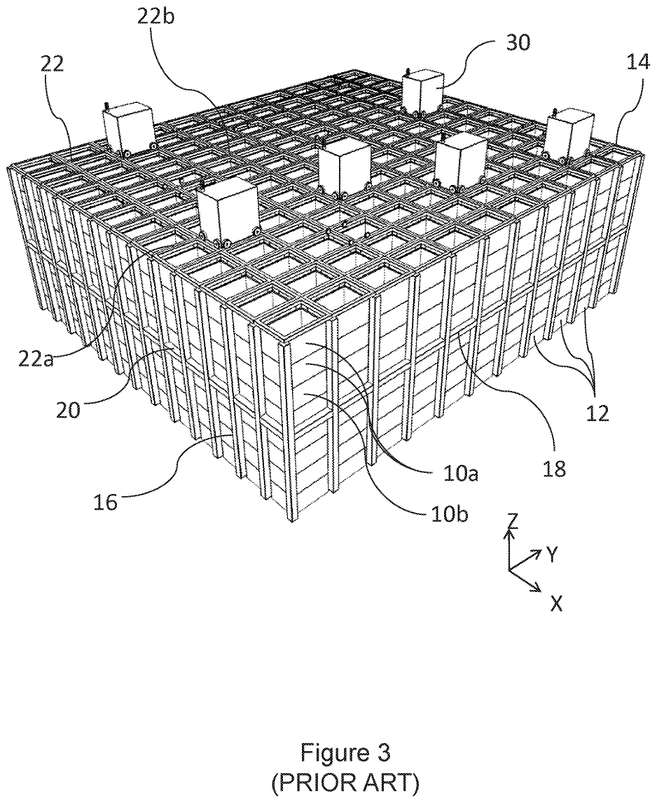

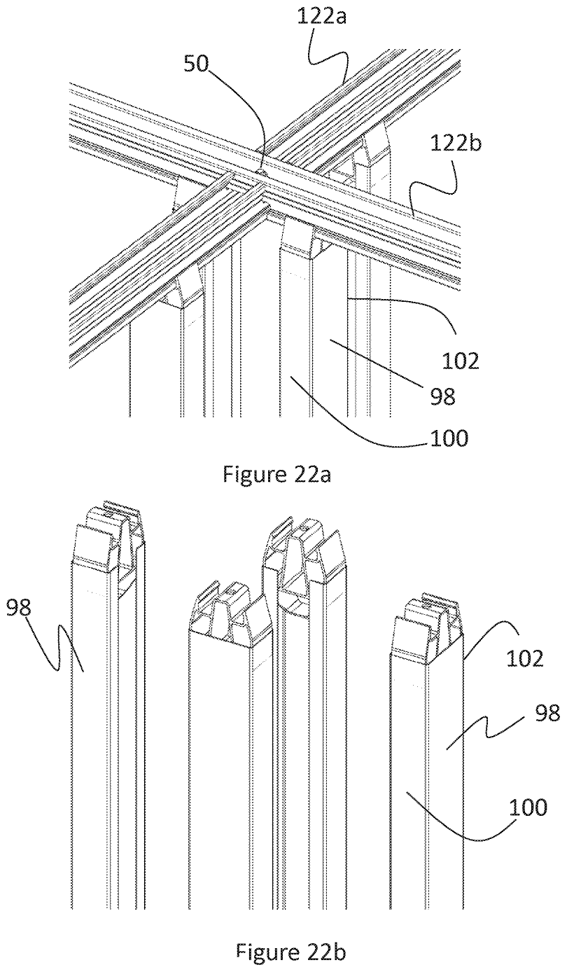

In comparison to the arrangement of the tote guides at the nodes 50 of the track system as shown in FIGS. 3 and 6, the plurality of tote guides 98 are shown in FIGS. 22a and 22b offset or spaced apart from the nodes 50. Instead of the plurality of tote guides being spatially distributed in the grid framework structure at the corners of the vertical members extending from the nodes of the track system, the plurality of tote guides are spatially distributed within the grid framework structure such that each of the plurality of tote guides extend between the nodes of the track system 84. Four tote guides are shown in FIG. 22a spatially offset or spaced apart from the node 50 of the track system. The plurality of tote guides can be positioned anywhere between the nodes of the track system. Having the plurality of tote guides offset from the nodes 50 rather than being at the nodes reduces the tendency of the grabber device and any storage container attached to the grabber device from twisting or deflecting as they are being hoisted in a vertical direction along the storage column by the robotic load handling device operable on the track system. Guiding along the sidewalls of the grabber device provides increased lateral stability in comparison to guiding by the corners. The offsetting nature of the tote guides also helps to provide a passageway for entry into the grid framework structure. Moreover, considering that the supporting framework structure is load bearing in the sense that the weight of the track system and robotic load handling devices operable on the track system is largely borne by the supporting framework structure, each of the plurality of tote guides can be discrete standalone structures removing the need for the totes guides to be braced.

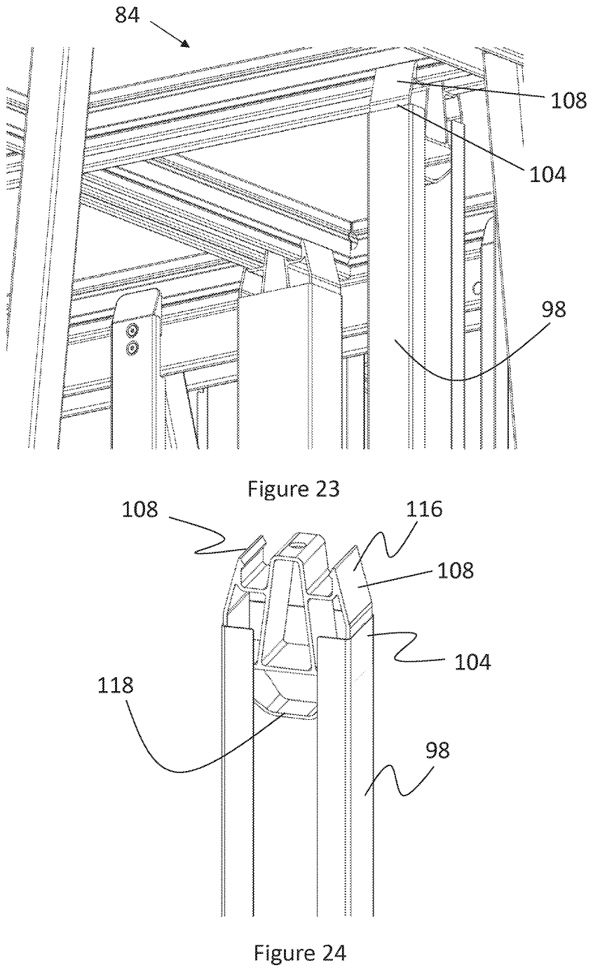

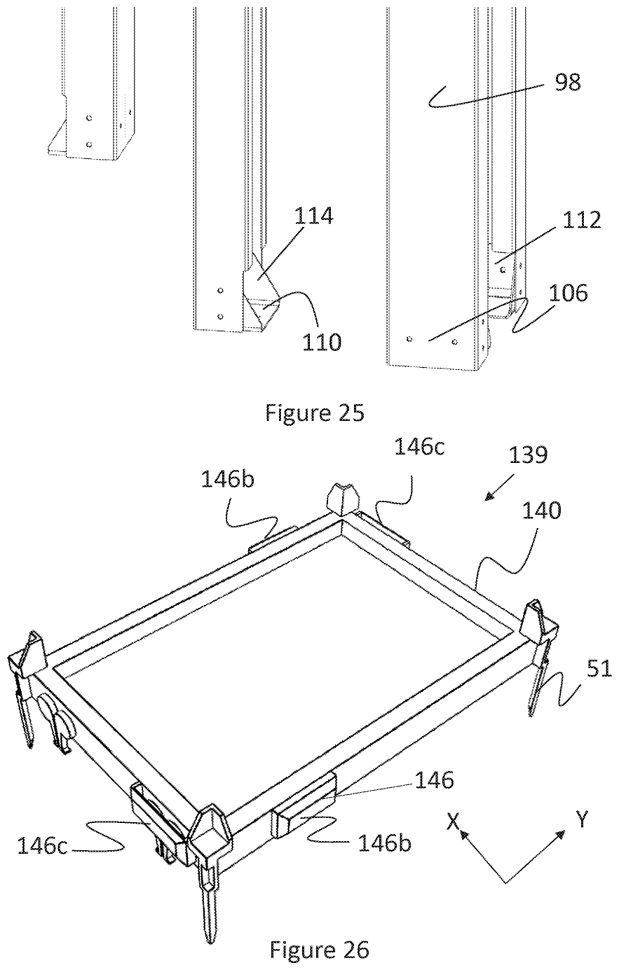

Each of the plurality of tote guides 98 are shown in FIG. 24 having a first end 104 anchored to the track system or the horizontal bracing member of the prefabricated frame as shown in FIG. 23 and a second end 106 anchored to the floor as shown in FIG. 25. A first attachment 108 anchors the first end 104 of the tote guide 98 to the track system or the horizontal bracing member of the prefabricated frame and a second attachment 110 anchors the second end of the tote guide to the floor. In the particular embodiment of the present invention shown in FIG. 25, the second attachment 110 is shown having a first portion 112 that is receivable in the U-shaped channel of the second end 106 of the tote guide 98 and a second portion 114 having one or more openings for receiving one or more anchor bolts. To prevent the grabber device and/or the storage container clashing or fouling the first end of the tote guide as they are being hoisted through a grid cell, the first attachment 108 comprises a wedged shaped guiding portion 116 that interfaces with the track system (see FIG. 24). Without the wedged shaped guiding portion 116 of the first attachment 108, the grabber device and/or the storage container may foul the first end 104 of the tote guide or track system when transitioning between the storage column and the track system and vice versa to the extent that the grabber device and/or storage container may get stuck within a storage column. The wedged shaped guiding portion 116 also provides a smooth transition of the grabber device and/or storage container as they are being guided along the first or second guide surface of the tote guide and through the grid cell of the track system. In the particular embodiment of the present invention shown in FIG. 24, the first attachment 108 comprises opposing wedged shaped guiding portions 116, each of the opposing wedged shaped portions respectively cooperates with the first and second guide surfaces of the tote guide for guiding the grabber device and/or storage container through neighbouring grid cells.

Like the second attachment 112 at the second end of the tote guide, the first attachment 116 is separately attached to the first end 104 of the tote guide 98. In the particular embodiment of the present invention shown in FIG. 24, the first attachment 108 comprises a snap-fit portion 118 that is receivable in the U-shaped channel of the tote guide in a snap-fit arrangement. The first attachment anchors the first end of the tote guide to the track system by being received in the U-shaped cross-sectional profile of the horizontal bracing member of the prefabricated frame 86a,b discussed above. However, other means to respectively attach the first end and/or the second end of each of the plurality of tote guides to the floor and the track system or prefabricated frame are permissible in the present invention. For example, the first and/or the second end of the tote guide can be respectively anchored to the track system and the floor via their respective first and second attachments by one or more anchor bolts.

In other examples, the tote guides 98 may be load-bearing, i.e. may help to support the weight of the track system and load handling devices. Load-bearing tote guides have the advantage of supporting the track system and therefor reducing deflection in the track structure.

In such examples, tote guides 98 may be braced together for increased structural stability. Advantageously, the bracing reduces deflection of the tote guides.

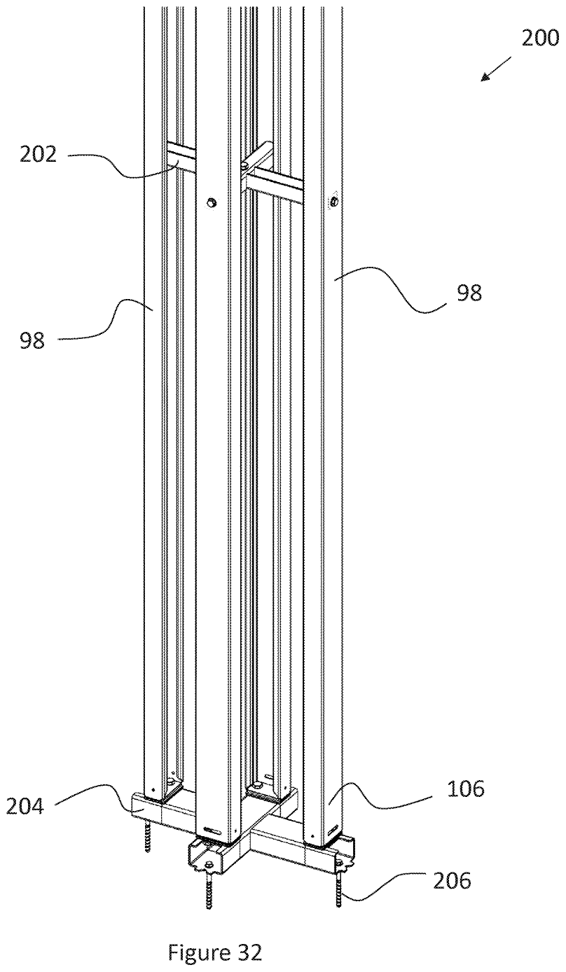

FIG. 32 illustrates a cluster of four tote guides 98 braced together. The tote guides form a braced tower 200. The tote guides 98 are braced together using a spacer 200 part way along the length of the tote guides, and an anchor 204 at the second end 106 (the lower end) of the tote guides 98.

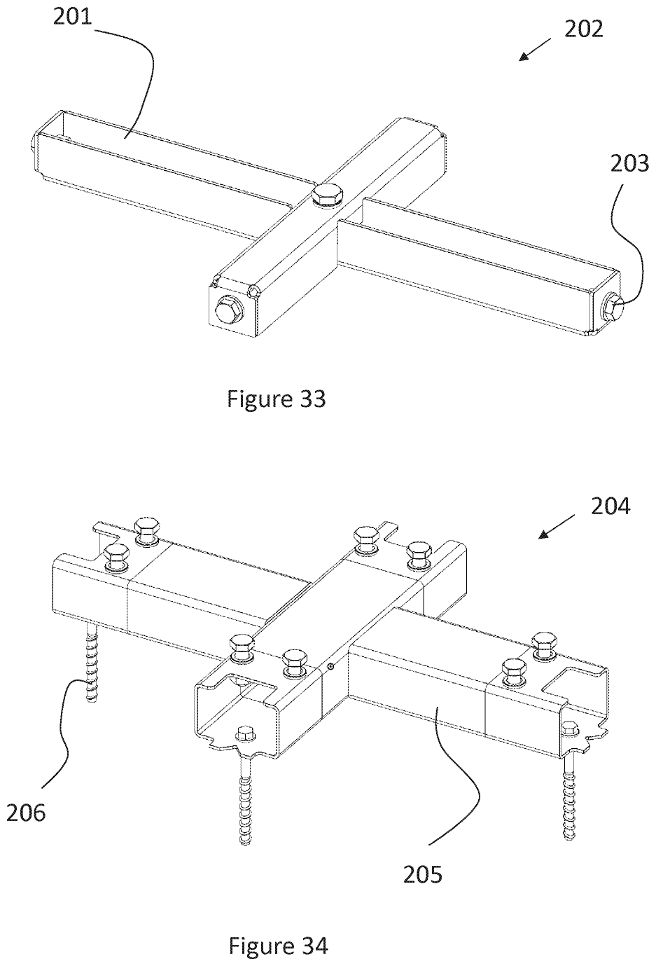

As illustrated in FIG. 33, the spacer 202 is cross-shaped, with four portions 201 extending perpendicularly. Each of the four portions 201 connects to a respective one of the four tote guides 98 in the braced tower 200. Bolts 203 are provided at the ends of the extending portions in order to bolt the spacer 202 to the tote guides. The tote guides 98 are provided with corresponding bolt holes.

As illustrated in FIG. 34, the anchor 204 is cross-shaped, with four portions 205 extending perpendicularly, in a similar manner to the spacer 202. Each of the four extending portions 205 can be bolted to a respective one of the four tote guides 98 in the braced tower 200. The extending portions are also provided with anchor bolts 206 for connecting the anchor 204 to the floor of the building where the grid framework structure is installed. A stronger connection to the ground may be needed in cases where the tote guides are load bearing.

Shims can be inserted in between the anchor 204 and the second end 106 (lower end) of the tote guides, in order to provide height adjustment. Advantageously, this permits adjustment of the tote guides 98 to account for manufacturing tolerances or any variation in the level of the floor.

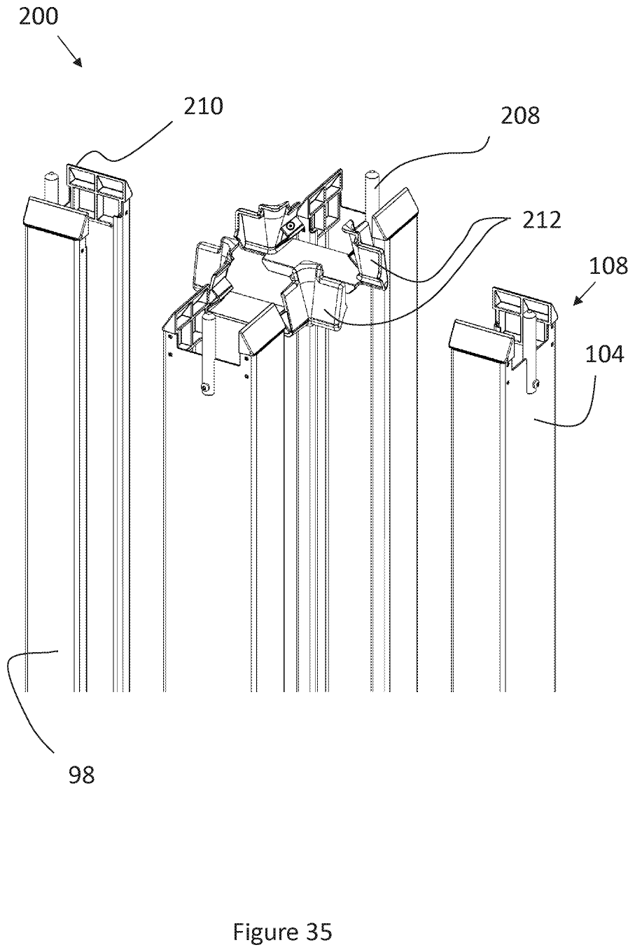

FIG. 35 illustrates the upper end of a braced tower formed from four tote guides 98. At the first end 106 (upper end) of the tote guides 98 is a first attachment 108. The illustrated example of the first attachment 108 is different from that described above with reference to FIG. 24. The first attachment is provided with a pair of opposing wedge-shaped protrusions 210. These wedge-shaped protrusions engage with the underside of the track. The wedge-shaped protrusions connect to the sections of track support in a snap-fit arrangement. Advantageously, this arrangement enables easy and fast assembly of the tote guides to the grid framework structure.

Guiding pins 208 are provided at the first end of each tote guide. These also help to ensure fast and easy assembly of the tote guides to the grid framework structure, by enabling the first end 106 of the tote guides 98 to be located in a corresponding recess in the underside of the track system.

Advantageously, the tote guides 98 can be assembled to the grid framework structure after the grid framework structure has been constructed. The tote guides can be easily removed for maintenance or replaced, or even retrofitted to an existing grid framework structure. The guiding pins 208 and the shims enabling height adjustment both facilitate easy assembly of the tote guides 98 after the grid framework structure has been assembled. In examples where the supporting structure comprises prefabricated panels,

Also illustrated in FIG. 35 are tapered corner pieces 212. These fulfil a similar function to the wedged shaped guiding portion 118 in the example of FIG. 24. The tapered corner pieces 212 prevent the corners of the grabber device and/or the storage container clashing or fouling the first end 106 of the tote guides 98 as the grabber device is lowered through a grid cell by a load handling device. The braced tower 200 described above is formed from four tote guides 98. However, in other examples a different number of tote guides can be braced together. For example, four tote guides can be braced together to form a freestanding tower in the centre of the grid framework structure, or three tote guides can be braced together to form a tower along an edge of the grid framework structure, or two tote guides can be braced together to form a freestanding tower in a corner of the grid framework structure.

In examples where the grid framework structure is built using prefabricated panels, tote guides can be built into the prefabricated panels as extra vertical members. Braced towers of four tote guides can be formed from two tote guides that are built in to a prefabricated panel and two freestanding tote guides. The four tote guides can be braced together in the same way as described above. Alternatively, the bracing can be between the two freestanding tote guides only, passing through the prefabricated panel.

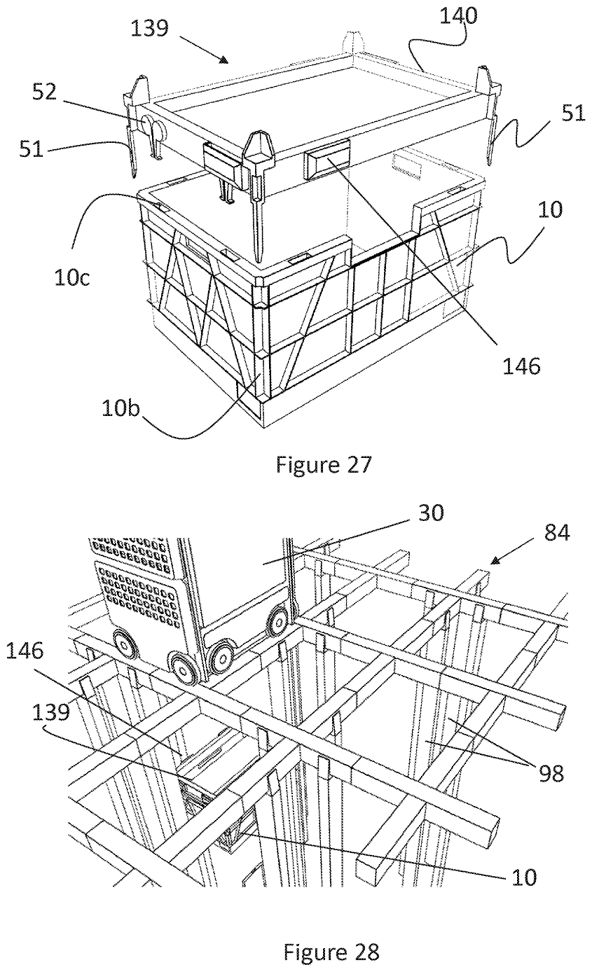

To accommodate the plurality of tote guides that are spatially distributed between the nodes of the track system, the lifting frame 140 of the grabber device 139 is adapted with rub or wear strips 146 that engages with the plurality of tote guides 98 as it is being hoisted in a vertical direction along the storage column by a robotic load handling device operable on the track system. FIG. 26 is a schematic view of the grabber device 139 according to one example of the present invention showing the lifting frame 140 with one or more rub or wear strips 146 mounted to the sidewalls of the lifting frame and which is configured to contact the guide surface 100, 102 of the plurality of tote guides 98 in a given storage column as it is being hoisted in a vertical direction and FIG. 27 show the lifting frame in FIG. 26 engaging with a storage container 10. In both figures, the locating pins or guide pins 51 nearby or at each corner of the grabber device 139 which mate with corresponding cut outs or holes 10b at the four corners of the storage container 10 are still present. The locating pins 51 ensure that the lifting frame 140 is correctly positioned on the rim of the storage container such that the gripper elements 52 are properly aligned with corresponding holes 10c in the rim of the storage container when engaging with the storage container.

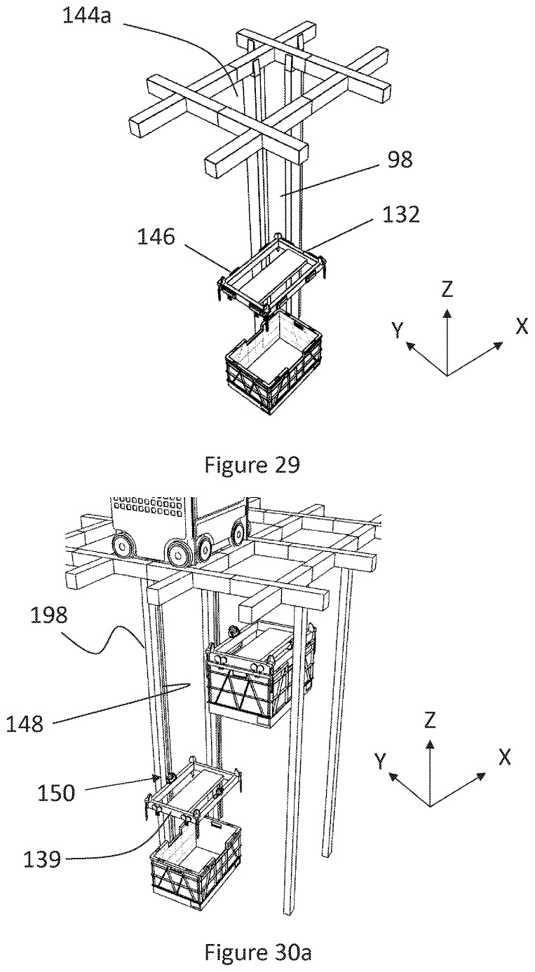

FIG. 28 shows schematic drawings of an example of the grabber device 139 being guided on all four sides by the plurality of totes guides 98 in a given storage column as it is being hoisted by a robotic load handling device 30 positioned above a stack of storage containers. The interaction of the grabber device 139 with the plurality of tote guides 98 via the wear strips 146 mounted to the sidewalls or sides of the lifting frame as the grabber device is being hoisted by the robotic load handling device is clearly seen in FIG. 29. Also shown in FIG. 29, is the absence of the need to guide the grabber device at the corners of the lifting frame. To mitigate wear of the tote guide and/or the lifting frame, preferably, the wear strip comprises a plastic material, e.g. PTFE (polytetrafluoroethylene). Alternatively or in addition to the wear strip mounted to the lifting frame of the grabber device, the guide surface of the tote guide can be coated with a wear resistant material, e.g. a plastic or ceramic coating.

Not only do the wear strips mitigate wear of the lifting frame against the guide surface of the plurality of tote guides as the lifting frame is being hoist in the vertical direction along the storage column, the wear strips correctly positions the lifting frame relative to the grid cell of the track system. Positioning of the lifting frame of the grabber device relative to the grid cell of the track system also correctly positons the storage container attached to the grabber device relative to the storage column. Correctly positioning the grabber device relative to the grid cell of the track system mitigates the risk of the storage container impacting the tote guides as it is being hoisted in the vertical direction along the storage column. This in turn ensures that the grabber device and/or the storage container is/are correctly received in the container receiving space of the robotic load handling device on the track system. In the particular embodiment of the present invention shown in FIG. 26, the wear strips 146 mounted on the sides or sidewalls of the lifting frame comprises a first set of wear strips 146b for positioning the grabber device in the X-direction relative to the grid cell and a second set of wear strips 146c for positioning the grabber in the Y-direction relative to the grid cell.

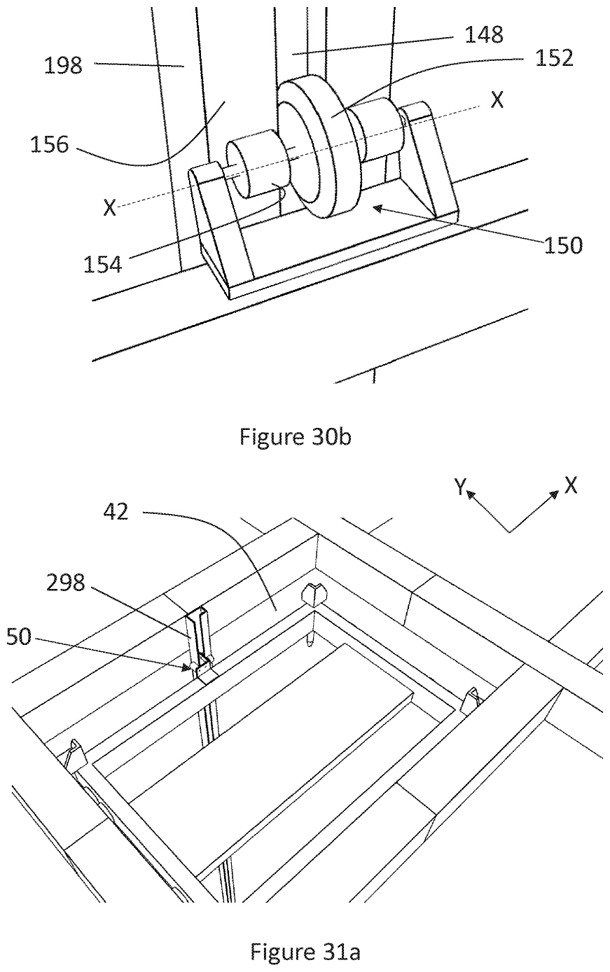

Alternatively or in addition to engaging with the plurality of tote guides by one or more wear strips mounted on the lifting frame, one or more rollers or wheels 150 can be mounted to the lifting frame that engages with the guide surface of the tote guide shown in FIG. 30(a and b). The tote guide 198 can optionally comprise a guide track extending in a longitudinal direction along the guide surface of the tote guide for interacting with the one or more rollers or wheels mounted to the lifting frame. In the particular embodiment shown in FIG. 30(a and b), the guide track comprises an elongated depression 148 extending longitudinally in a vertical direction along the tote guide 198 for guiding the one or more rollers 150 along the guide surface. Each of the one or more rollers 150 are passive or freewheeling in the sense that each of the rollers rotate as the grabber device is hoisted up or down the storage column. The one or more rollers is shown comprising a retention roller or wheel 152 that is sized to be received within the elongated depression 148 of the tote guide 198 and running rollers or wheels 154 laterally disposed either side of the retention roller 152. The retention roller 152 is received within the elongated depression 148 of the tote guide 198 and is configured to constrain the movement of the grabber device horizontally in either the X-direction or the Y-direction, as the grabber device is being hoisted in the vertical, Z, direction. In the particular embodiment shown in FIG. 30b, the retention roller 152 rotate about an axis X-X and thereby, constrain the grabber device from movement along a horizontal axis substantially parallel to the rotation axis, X-X. Laterally disposed either side of the elongated depression 148 of the tote guide 198 are running surfaces 156 that configured to interact or cooperate with the running wheels or rollers 154 of the grabber device. The ability of the retention wheel 154 to being received within the elongated depression 148 of the guide surface prevents movement of the lifting frame in the X-direction or the Y-direction and therefore, confines the lifting frame to being guided in a substantially vertical direction. As a result, at least two tote guides are necessary to guide the grabber device in the vertical direction to constrain movement of the grabber device in the X direction and in the Y direction reducing the need to guide the grabber device on all four sides or sidewalls of the lifting frame. Equally, the grabber device comprises at least two sets of rollers or wheels arranged to respectively cooperate with the at least two tote guides, each of the at least two sets of wheels comprises a retention roller or wheel 152 that is sized to be received within the elongated depression 148 of a respective tote guide 198 of the at least two tote guides and running rollers or wheels 154 laterally disposed either side of the retention roller 152. To interact with the at least two tote guides, the one or more rollers or wheels comprises a first set of wheels 158 and a second set of the wheels 160 for constraining movement of the grabber device 139 in the horizontal plane. More specifically, the first set of wheel 158 retains or constrains the movement of the grabber device in the X-direction and the second set of wheels 160 retains or constrains the movement of the grabber device in the Y-direction. To retain or constrain the movement of the grabber device in the X-direction and in the Y-direction, the first set of wheels 158 is configured to rotate about a first axis, Y-Y, and the second set of wheels 160 is configured to rotate about a second axis, X-X, wherein the first axis, Y-Y, is substantially perpendicular to the second axis, X-X.

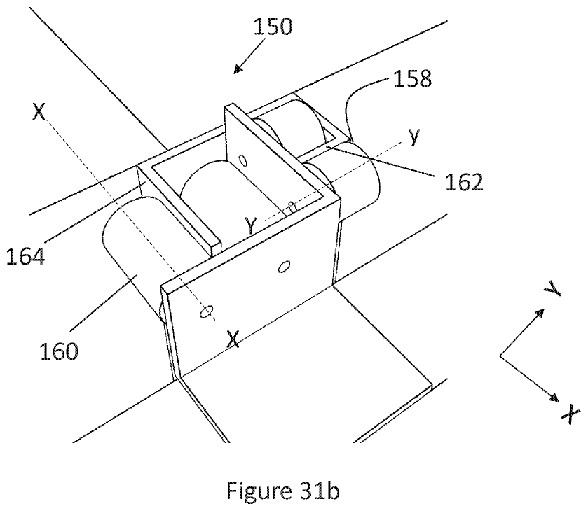

In yet a further embodiment of the present invention, the one or more rollers or wheels mounted on the lifting frame can interact or cooperate with a single tote guide. Like the second embodiment of the tote guide, to retain or constrain the movement of the grabber device in the X-direction and in the Y-direction, the one or more rollers or wheels comprises a first set of wheels and a second set of wheels, the first set of wheels 158 is configured to rotate about a first axis, Y-Y, and the second set of wheels 160 is configured to rotate about a second axis, X-X, wherein the first axis, Y-Y, is substantially perpendicular to the second axis, X-X. In contrast to having at least two tote guides to constrain movement of the grabber device in the X direction and the Y direction, the tote guide 298 comprises a first retention means 162 for interacting with the first set of wheels 158 and a second retention means 164 for interacting with the second set of wheels 160. To constrain the movement of the grabber device in the X-direction and in the Y-direction, the first retention means 162 comprises a first retention surface extending in a first direction, Y-Y, and the second retention means comprises a second retention surface extending in a second direction, X-X, the second direction being substantially perpendicular to the first direction. Each of the first and second retention surfaces 162, 164 being configured to respectively interact with the first and second sets of wheels 158, 160 to guide the grabber device in the vertical direction along the storage column. In the particular embodiment of the present invention shown in FIG. 31b, the first retention surface 162 comprises a first plate extending in the first direction, Y-Y, the first direction being substantially parallel to the first axis of rotation. The second retention surface 164 comprises a second plate extending in the second direction, X-X, the second direction being substantially parallel to the second axis of rotation, X-X. The first and second retention surfaces can be integrated into a single tote guide to constrain the movement of the grabber device horizontally in both the X-direction and Y-direction but allows movement in the substantially vertical direction. For example, the first and second retention surfaces can be provided by one or more bends in a sheet metal blank.

Like the embodiment described above with respect to FIG. 30b, the first and second sets of wheels 158, 160 are passive or freewheeling and rotate when the grabber device is hoisted in the vertical direction by a robotic load handling device operable on the track system. In comparison to the embodiment shown in FIG. 30b, only a single tote guide 298 is necessary to constrain the movement of the grabber device horizontally in the X-direction and in the Y-direction in a given storage column but allowing movement vertically in the Z-direction. Moreover, the tote guide 298 can interact with a single side or sidewall of the lifting frame of the grabber device. However, the present invention is not limited to guiding the grabber device along a single side of the lifting frame by the tote guide shown in FIG. 31a. The grabber device can be guided in the vertical direction by engaging at least two tote guides with at least two sides or sidewalls of the lifting frame. Moreover, the first and second retention surfaces can also help ensure that the lifting frame remains substantially horizontal as the lifting frame is being hoisted in the vertical direction.

While the particular embodiment describes the tote guides of the present invention with respect to the grid framework structure described with reference to FIG. 15, the tote guides according to the present invention can also be incorporated into the “stick-built” approach to building the grid framework structure described with reference to FIG. 1. Instead of the tote guides being at the corners of the vertical members or uprights, the plurality of tote guides are spatially distributed between the nodes of the track system to provide increased lateral stability of the plurality of tote guides in the horizontal direction.

What is claimed is:

1. A grid framework structure for supporting one or more robotic load handling devices operative on the grid framework structure, each of said one or more robotic load handling devices comprising a) a wheel assembly for guiding the load handling device on the track system; b) a container-receiving space located above the track system; and c) a lifting device arranged to lift a storage container from a stack into the container-receiving space, said lifting device comprises a set of lifting tethers and a grabber device for releasable connection to a storage container, the grid framework structure comprising:
a supporting framework structure comprising a plurality of storage columns, each of the plurality of storage columns being arranged to accommodate a stack of storage containers; and
a track system comprising a plurality of tracks arranged to form a grid pattern comprising a plurality of grid cells, said track system is mounted on the supporting framework structure such that each stack of storage containers is arranged below a grid cell;
wherein each of the plurality of storage columns comprises at least one tote guide for guiding the grabber device in a substantially vertical direction through a grid cell, said at least one tote guide being arranged such that, in use, the grabber device is guided through the grid cell along at least one sidewall of the grabber device.

2. The grid framework structure of claim 1, wherein the at least one tote guide in a given storage column is interposed between the intersections of the plurality of tracks.

3. The grid framework structure of claim 2, wherein each of the at least one tote guide is configured to engage with a single sidewall of the grabber device.

4. The grid framework structure of claim 1, wherein the at least one tote guide comprises a first guide tote surface and a second tote guide surface, the first guide surface being arranged to guide the grabber device in a substantially vertical direction through a grid cell and the second guide surface being arranged to guide the grabber device in a substantially vertical direction through an adjacent grid cell.

5. The grid framework structure of claim 4, wherein the at least one tote guide has a cross-sectional profile that is substantially U-shaped or C-shaped.

6. The grid framework structure of claim 5, wherein the at least one tote guide is formed from a sheet metal blank.

7. The grid framework structure of claim 1, wherein the supporting framework structure comprises a plurality of prefabricated frames arranged in a three dimensional grid pattern comprising a plurality of modular storage cells for the storage of a plurality of stacks of containers such that adjacent modular storage cells share a common prefabricated frame, each of the plurality of prefabricated frames lying in a vertical plane and comprising a plurality of vertical members braced by a bracing member.

8. The grid framework structure of claim 7, wherein the bracing member comprises one or more horizontal and/or diagonal bracing members.

9. The grid framework structure of claim 8, wherein the at least one tote guide comprises a first end anchored to the one or more horizontal bracing members of one or more of the plurality of prefabricated frames or the track system and a second end anchored to the floor.

10. The grid framework structure of claim 9, wherein the first end of the at least one tote guide is anchored to the one or more horizontal bracing members of one or more of the plurality of prefabricated frames or the track system by a first attachment, said first attachment comprising a wedged shaped portion that is configured to interface with the track system, and the second end of the at least one tote guide is anchored to floor by a second attachment.

11. The grid framework structure of claim 7, wherein each of the prefabricated frames comprises an A-frame.

12. The grid framework structure of claim 1, wherein the at least one tote guide comprises a tote guide track for engaging with the grabber device, said tote guide track extending in a longitudinal direction along the tote guide.

13. The grid framework structure of claim 12, wherein the tote guide track comprises an elongated depression extending in a longitudinal direction of the at least one tote guide for engaging with the grabber device.

14. The grid framework structure of claim 1, wherein the at least one tote guide comprises a plurality of tote guides, each of the plurality of tote guides being arranged in the storage column to engage with a different sidewall of the grabber device.

15. The grid framework structure of claim 14, wherein the plurality of tote guides are arranged such that, in use, the grabber device is guided along at least two sidewalls of the grabber device.

16. The grid framework structure of claim 1, wherein the at least one tote guide comprise a first retention surface for constraining movement of the grabber device in a first direction and a second retention surface for constraining movement of the grabber device in a second direction, the second direction being substantially perpendicular to the first direction.

17. The grid framework structure of claim 1, wherein the at least one tote guide and at least one tote guide in an adjacent grid cell are braced together with at least one bracing member.

18. The grid framework structure of claim 1, wherein the at least one tote guide is configured to connect to the underside of the track system using a snap-fit arrangement.

19. A storage and retrieval system comprising:
i) a grid framework structure according to claim 1;
ii) a plurality of stacks of storage containers arranged in storage columns located below the track system, wherein each storage column is located vertically below a grid cell; and
iii) a plurality of load handling devices for lifting and moving containers stacked in the stacks, the plurality of load handling devices being remotely operated to move laterally on the track system above the storage columns to access the containers through the grid cells, each of said plurality of load handling devices comprising:
a) a wheel assembly for guiding the load handling device on the track system;
b) a container-receiving space located above the track system; and
c) a container lifting mechanism comprising a grabber device for releasable connection to a storage container, said container lifting mechanism being arranged to lift a single container from a stack into the container-receiving space.

20. The storage and retrieval system of claim 19, wherein the grabber device comprise a lifting frame comprising one or more gripper elements that is configured to releasably engage with the storage container, said lifting frame being configured to interact with the at least one tote guide as it is guided in the vertical direction along the storage column.
